(19) United States
(12) Patent Application Publication
(10) Pub. No.: US 2020/0002232 A1
(43) Pub. Date: Jan. 2, 2020

(54) POROUS ACID-RESISTANT CERAMIC MEDIA

(71) Applicant: Saint-Gobain Ceramics & Plastics, Inc., Worcester, MA (US)

(72) Inventor: John S Reid, Wooster, OH (US)

(73) Assignee: Saint-Gobain Ceramics & Plastics, Inc., Worcester, MA (US)

(21) Appl. No.: 16/453,421

(22) Filed: Jun. 26, 2019

Related U.S. Application Data
(60) Provisional application No. 62/691,664, filed on Jun. 29, 2018.

(51) Int. Cl. C04B 35/14; C04B 35/22; C04B 35/20; C04B 35/185; C04B 38/00; C04B 33/16

(52) U.S. Cl. CPC C04B 35/14; C04B 35/22; C04B 35/20; C04B 33/16; C04B 38/0058; C04B 38/0074; C04B 35/185

(57) ABSTRACT

The present disclosure relates to a porous ceramic media that may include a chemical composition, a phase composition, a total open porosity content of at least about 10 vol. % and not greater than about 70 vol. % as a percentage of the total volume of the ceramic media, and a nitric acid resistance parameter of not greater than about 500 ppm. The chemical composition for the porous ceramic media may include SiO₂, Al₂O₃, an alkali component and a secondary metal oxide component selected from the group consisting of an Fe oxide, a Ti oxide, a Ca oxide, a Mg oxide and combinations thereof. The phase composition may include an amorphous silicate, quartz and mullite.

### CROSS-REFERENCE TO RELATED APPLICATION

This application claims the benefit of U.S. Provisional Application No. 62/691,664 filed Jun. 29, 2018.

### FIELD OF THE DISCLOSURE

The following is directed generally to a porous ceramic media, and more particularly to an acid-resistance ceramic media and methods of making the same.

### BACKGROUND

In the chemical processing industry, acid resistant materials with high open porosity content are beneficial because they can be coated with a catalyst material, and then used as a catalyst in an acidic environment. In other words, there is a need for acid resistant materials with high open porosity content for use as catalyst carrier media. Commercially available catalyst carriers and other known porous ceramic media with high open porosity content (i.e., an open porosity content of at least about 20 volume percent) are generally not resistant to various acids in high concentration and/or at elevated temperatures. Alternatively, commercially available catalyst carriers and other known porous ceramic media that are highly resistant to hot and/or concentrated acids are typically very dense with little to no open porosity. Accordingly, the industry continues to demand improved catalyst carriers and porous media that have the combined benefit of high acid resistance and high open porosity content.

### SUMMARY

According to a first aspect, a porous ceramic media may include a chemical composition, a phase composition, a total open porosity content of at least about 25 vol. % and not greater than about 55 vol. % as a percentage of the total volume of the ceramic media, and a nitric acid resistance parameter of not greater than about 500 ppm. The chemical composition for the porous ceramic media may include SiO₂, Al₂O₃, an alkali component and a secondary metal oxide component selected from the group consisting of an Fe oxide, a Ti oxide, a Ca oxide, an Mg oxide and combinations thereof. The phase composition may include an amorphous silicate, quartz and mullite.

According to yet another aspect, a method of forming a porous ceramic media may include providing a raw material mixture, and forming the raw material mixture into a porous ceramic media. The raw material mixture may include clay, feldspar, raw perlite and SiC. The porous ceramic media may include a phase composition, a total open porosity content of at least about 25 vol. % and not greater than about 55 vol. % as a percentage of the total volume of the ceramic media, and a nitric acid resistance parameter of not greater than about 500 ppm. The phase composition may include an amorphous silicate, quartz and mullite.

### BRIEF DESCRIPTION OF THE DRAWINGS

Embodiments are illustrated by way of example and are not limited to the accompanying figures.

FIG. 1 is an illustration of a flowchart of a method of making a porous ceramic media in accordance with an embodiment;

FIG. 2 includes a plot of the “Total Open Porosity” versus the “Nitric Acid Resistance Parameter” measured for the porous ceramic media samples formed according to embodiments described herein and comparative samples; and

FIG. 3 includes a plot of the “Total Open Porosity” versus the “HCl Acid Resistance Parameter” measured for the porous ceramic media samples formed according to embodiments described herein and comparative samples.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B is true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

As used herein the term “nitric acid resistance parameter” refers to a measurement using ICP analysis of the total mass of porous ceramic media leached from a representative sample of the porous ceramic media after the sample is placed in boiling 10% nitric acid solution for 15 minutes. For purposes of embodiments described herein, a nitric acid resistance parameter of a particular sample of porous ceramic media is measured according to a nitric acid resistance test including the follow steps: 1) prepare a 10% W/V nitric acid dilution by filling a 1000 mL volumetric flask a quarter full of DI water, adding 107 mL of ˜70% nitric acid and mixing, filling the volumetric flask close to the line with DI water, allowing the mixture to cool to room temperature, filling the flask to volume and mixing well, 2) perform a 10% nitric HP leachable analysis by preheating a hot plate between 380-400° C., weighing and recording a ˜10 g sample of the porous ceramic media into a 200 mL beaker, adding 100 mL of the 10% nitric acid dilution prepared in step 1 to the sample, preparing a blank by adding 100 mL of the 10% nitric acid dilution prepared in step 1 to an empty beaker, placing watch glasses onto the beakers, boiling the sample and the blank on a hot plate for 15 minutes, removing the sample and the blank from the hot plate, 3) separating the remaining solid media sample from the liquid with a screen from the sample beaker, rinsing and drying the solid media sample, and weighing and recording the dried media sample, then 4) filtering the sample liquid and the blank each through a Whatman® #40 into a 200 mL volumetric flask, rinsing the sample and blank with three 25 mL portions of DI water (allowing each to drain completely), removing the filter and the rinse funnel, allowing the sample and blank to cool, diluting the sample and blank to the mark, mixing each the diluted sample and blank well, and 5) analyzing the contents of each by ICP and reporting the amount in ppm for each element detected, and adding to obtain the sum of all the ppm amounts.

As used herein the term “nitric acid weight loss parameter” refers to the change in weight of the solid media sample by subtracting the final weight in step 3 of the procedure outlined above regarding the “nitric acid resistance parameter” from the initial weight in step 2 of the procedure outlined above regarding the “nitric acid resistance parameter”, and expressing the result as a percent weight loss.

As used herein the term “HCl acid resistance parameter” refers to a measurement using ICP analysis of the total mass of porous ceramic media leached from representative sample after the sample is placed in boiling 10% HCl acid solution for 15 minutes. For purposes of embodiments described herein, a HCl acid resistance parameter of a particular sample of porous ceramic media is measured according to a HCl acid resistance test including the follow steps: 1) prepare a 10% W/V HCl acid dilution by filling a 1000 mL volumetric flask a quarter full of DI water, adding 100 mL of ˜38% HCl acid and mixing, filling the volumetric flask close to the line with DI water, allowing the mixture to cool to room temperature, filling the flask to volume and mixing well, 2) perform a 10% HCl HP leachable analysis by preheating a hot plate to 310° C., weighing and recording a ˜50 g sample of the porous ceramic media into a 250 mL Erlenmeyer flask, adding 250 mL of the 10% HCl acid dilution prepared in step 1 to the sample, connecting the condenser column onto the Erlenmeyer flask, turning on the column water, preparing a blank by adding 25 mL of the 10% HCl acid dilution prepared in step 1 to an empty beaker, boiling the sample and the blank on hot plate for 2 hours, removing the sample and the blank from hot plate, 3) separating the remaining solid media sample from the liquid with a screen from the sample beaker, rinsing and drying the solid media sample, and weighing and recording the dried media sample, then 4) filtering the sample liquid and the blank each through a Whatman® #40 into a 500 mL volumetric flask, rinsing the sample and the blank with three 50 mL portions of DI water (allowing each to drain completely), removing the filter and the rinse funnel, allowing the sample and the blank to cool, diluting the sample and the blank to the mark, mixing each the diluted sample and blank well, and 5) analyzing the contents of each by ICP and reporting the amount in ppm for each element detected, and adding to obtain the sum of all the ppm amounts.

As used herein the term “HCl acid weight loss parameter” refers to the change in weight of the solid media sample by subtracting the final weight in step 3 of the procedure outlined above regarding the “HCl acid resistance parameter” from the initial weight in step 2 of the procedure outlined above regarding the “HCl acid resistance parameter”, and expressing the result as a percent weight loss.

According to particular embodiments described herein, a porous ceramic media may include a particular chemical composition, a particular phase composition, a particular total open porosity content, and a particular nitric acid resistance parameter.

Referring to the particular chemical composition, according to certain embodiments, the chemical composition of the porous ceramic media may include SiO₂, Al₂O₃, an alkali component and a secondary metal oxide component selected from the group consisting of an Fe oxide, a Ti oxide, a Ca oxide, a Mg oxide and combinations thereof.

According to yet other embodiments, the chemical composition of the porous ceramic media may include a particular content of SiO₂. For example, the porous ceramic media may include a SiO₂ content of at least about 65.0 wt. % as a percentage of the total weight of the porous ceramic media, such as, at least about 65.5 wt. % or at least about 66.0 wt. % or at least about 66.5 wt. % or at least about 67.0 wt. % or at least about 67.5 wt. % or at least about 68.0 wt. % or at least about 68.5 wt. % or at least about 69.0 wt. % or at least about 69.5 wt. % or even at least about 70 wt. %. According to still other embodiments, the porous ceramic media may include a SiO₂ content of not greater than about 85 wt. % as a percentage of the total weight of the porous ceramic media, such as, not greater than about 84.5 wt. % or not greater than about 84.0 wt. % or not greater than about 83.5 wt. % or not greater than about 83.0 wt. % or not greater than about 82.5 wt. % or not greater than about 82.0 wt. % or not greater than about 81.5 wt. % or not greater than about 81.0 wt. % or not greater than about 80.5 wt. % or not greater than about 80.0 wt. % or not greater than about 79.5 wt. % or not greater than about 79.0 wt. % or even not greater than about 78.5 wt. %. It will be appreciated that the SiO₂ content in the porous ceramic media may be any value between, and including, any of values noted above. It will be further appreciated that the SiO₂ content in the porous ceramic media may be within a range between, and including, any of the values noted above.

According to still other embodiments, the chemical composition of the porous ceramic media may include a particular content of Al₂O₃. For example, the porous ceramic media may include an Al₂O₃ content of at least about 10 wt. % as a percentage of the total weight of the porous ceramic media, such as, at least about 10.5 wt. % or at least about 11.0 wt. % or at least about 11.5 wt. % or at least about 12.0 wt. % or at least about 12.5 wt. % or at least about 13.0 wt. % or at least about 13.5 wt. % or even at least about 14 wt. %. According to still other embodiments, the porous ceramic media may include an Al₂O₃ content of not greater than about 30 wt. % as a percentage of the total weight of the porous ceramic media, such as, not greater than about 29.5 wt. % or not greater than about 29.0 wt. % or not greater than about 28.5 wt. % or not greater than about 28.0 wt. % or not greater than about 27.5 wt. % or not greater than about 27.0 wt. % or not greater than about 26.5 wt. % or not greater than about 26.0 wt. % or not greater than about 25.5 wt. % or not greater than about 25.0 wt. % or not greater than about 24.5 wt. % or not greater than about 24.0 wt. % or not greater than about 23.5 wt. % or not greater than about 23.0 wt. % or even not greater than about 22.5 wt. %. It will be appreciated that the Al₂O₃ content in the porous ceramic media may be any value between, and including, any of values noted above. It will be further appreciated that the Al₂O₃ content in the porous ceramic media may be within a range between, and including, any of the values noted above.

According to yet other embodiments, the alkali component of the chemical composition of the porous ceramic media may include Na₂O. According to other embodiments, the alkali component of the chemical composition of the porous ceramic media may include K₂O. According to still other embodiments, the alkali component of the chemical composition of the porous ceramic media may include Li₂O. According to yet other embodiments, the alkali component of the chemical composition of the porous ceramic media may include a combination of an alkali component selected from the group consisting of Na₂O, K₂O and Li₂O.

According to yet other embodiments, the porous ceramic media may include a particular total content of the alkali component. For example, the porous ceramic media may include a alkali component total content of at least about 2.0 wt. % as a percentage of the total weight of the porous ceramic media, such as, at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or even at least about 3.0 wt. %. According to still other embodiments, the porous ceramic media may include an alkali component total content of not greater than about 8.0 wt. % as a percentage of the total weight of the porous ceramic media or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or even not greater than about 7.0 wt. %. It will be appreciated that the total content of the alkali component in the porous ceramic media may be any value between, and including, any of values noted above. It will be further appreciated that the total alkali component content in the porous ceramic media may be within a range between, and including, any of the values noted above.

According to yet other embodiments, the porous ceramic media may include a particular content of Na₂O. For example, the porous ceramic media may include a Na₂O content of at least about 2.0 wt. % as a percentage of the total weight of the porous ceramic media, such as, at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or even at least about 3.0 wt. %. According to still other embodiments, the porous ceramic media may include a Na₂O content of not greater than about 8.0 wt. % as a percentage of the total weight of the porous ceramic media or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or even not greater than about 7.0 wt. %. It will be appreciated that the content of Na₂O in the porous ceramic media may be any value between, and including, any of values noted above. It will be further appreciated that the Na₂O content in the porous ceramic media may be within a range between, and including, any of the values noted above.

According to yet other embodiments, the porous ceramic media may include a particular content of K₂O. For example, the porous ceramic media may include a K₂O content of at least about 2.0 wt. % as a percentage of the total weight of the porous ceramic media, such as, at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or even at least about 3.0 wt. %. According to still other embodiments, the porous ceramic media may include a K₂O content of not greater than about 8.0 wt. % as a percentage of the total weight of the porous ceramic media or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or even not greater than about 7.0 wt. %. It will be appreciated that the content of K₂O in the porous ceramic media may be any value between, and including, any of values noted above. It will be further appreciated that the K₂O content in the porous ceramic media may be within a range between, and including, any of the values noted above.

According to yet other embodiments, the porous ceramic media may include a particular content of Li₂O. For example, the porous ceramic media may include a Li₂O content of at least about 2.0 wt. % as a percentage of the total weight of the porous ceramic media, such as, at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or even at least about 3.0 wt. %. According to still other embodiments, the porous ceramic media may include a Li₂O content of not greater than about 8.0 wt. % as a percentage of the total weight of the porous ceramic media or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or even not greater than about 7.0 wt. %. It will be appreciated that the content of Li₂O in the porous ceramic media may be any value between, and including, any of values noted above. It will be further appreciated that the Li₂O content in the porous ceramic media may be within a range between, and including, any of the values noted above.

According to yet other embodiments, the secondary metal oxide component may consist of an Fe oxide. According to still other embodiments, the secondary metal oxide component may consist of a Ti oxide. According to yet other embodiments, the secondary metal oxide component may consist of a Ca oxide. According to still other embodiments, the secondary metal oxide component may consist of a Mg oxide.

According to yet other embodiments, the porous ceramic media may include a particular total content of the secondary metal oxide component. For example, the porous ceramic media may include a secondary metal oxide component total content of at least about 1.0 wt. % as a percentage of the total weight of the porous ceramic media, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media may include a secondary metal oxide component total content of not greater than about 5.0 wt. % as a percentage of the total weight of the porous ceramic media or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the total content of the secondary metal oxide component in the porous ceramic media may be any value between, and including, any of values noted above. It will be further appreciated that the total content of the secondary metal oxide component in the porous ceramic media may be within a range between, and including, any of the values noted above.

According to yet other embodiments, the porous ceramic media may include a particular content of an Fe oxide. For example, the porous ceramic media may include an Fe oxide content of at least about 1.0 wt. % as a percentage of the total weight of the porous ceramic media, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media may include an Fe oxide content of not greater than about 5.0 wt. % as a percentage of the total weight of the porous ceramic media or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the content of Fe oxide in the porous ceramic media may be any value between, and including, any of values noted above. It will be further appreciated that the content of Fe oxide in the porous ceramic media may be within a range between, and including, any of the values noted above.

According to yet other embodiments, the porous ceramic media may include a particular content of a Ti oxide. For example, the porous ceramic media may include a Ti oxide content of at least about 1.0 wt. % as a percentage of the total weight of the porous ceramic media, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media may include a Ti oxide content of not greater than about 5.0 wt. % as a percentage of the total weight of the porous ceramic media or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the content of Ti oxide in the porous ceramic media may be any value between, and including, any of values noted above. It will be further appreciated that the content of Ti oxide in the porous ceramic media may be within a range between, and including, any of the values noted above.

According to yet other embodiments, the porous ceramic media may include a particular content of a Ca oxide. For example, the porous ceramic media may include a Ca oxide content of at least about 1.0 wt. % as a percentage of the total weight of the porous ceramic media, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media may include a Ca oxide content of not greater than about 5.0 wt. % as a percentage of the total weight of the porous ceramic media or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the content of Ca oxide in the porous ceramic media may be any value between, and including, any of values noted above. It will be further appreciated that the content of Ca oxide in the porous ceramic media may be within a range between, and including, any of the values noted above.

According to yet other embodiments, the porous ceramic media may include a particular content of a Mg oxide. For example, the porous ceramic media may include a Mg oxide content of at least about 1.0 wt. % as a percentage of the total weight of the porous ceramic media, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media may include a Mg oxide content of not greater than about 5.0 wt. % as a percentage of the total weight of the porous ceramic media or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the content of Mg oxide in the porous ceramic media may be any value between, and including, any of values noted above. It will be further appreciated that the content of Mg oxide in the porous ceramic media may be within a range between, and including, any of the values noted above.

According to still other embodiments, the phase composition of the porous ceramic media may include an amorphous silicate. According to yet other embodiments, the phase composition of the porous ceramic media may include quartz. According to still other embodiments, the phase composition of the porous ceramic media may include mullite. According to other embodiments, the phase composition of the porous ceramic media may include a combination of an amorphous silicate, quartz or mullite. According to yet other embodiments, the phase composition of the porous ceramic media may include an amorphous silicate, quartz and mullite.

According to yet other embodiments, the porous ceramic media may include a particular total open porosity content. Open porosity as described herein is determined by mercury intrusion using pressures from 25 to 60,000 psi, using a Micrometrics® Autopore™ 9500 model (130° contact angle, mercury with a surface tension of 0.480 N/m, and no correction for mercury compression). The resulting measurement is multiplied by the material density or particle density of the material and then multiplied by 100 in order to convert the measurement to volume percent porosity. According to certain embodiments, the porous ceramic media may include a total open porosity content of at least about 10 vol. % as a percentage of the total volume of the porous ceramic media, such as, at least about 1 vol. % or at least about 12 vol. % or at least about 13 vol. % or at least about 14 vol. % or at least about 15 vol. % or at least about 16 vol. % or at least about 17 vol. % or at least about 18 vol. % or at least about 19 vol. % or at least about 20 vol. % or at least about 21 vol. % or at least about 22 vol. % or at least about 23 vol. % or at least about 24 vol. % or even at least about 25 vol. %. According to still other embodiments, the porous ceramic media may include a total open porosity content of not greater than about 70 vol. % as a percentage of the total volume of the porous ceramic media, such as, not greater than about 65 vol. % or not greater than about 60 vol. % or not greater than about 55 vol. % or not greater than about 50 vol. % or not greater than about 45 vol. % or not greater than about 40 vol. %. It will be appreciated that the total open porosity content in the porous ceramic media may be any value between, and including, any of values noted above. It will be further appreciated that the total open porosity content in the porous ceramic media may be within a range between, and including, any of the values noted above.

According to still other embodiments, the porous ceramic media may include a particular total open porosity content. Open porosity as described herein is determined by mercury intrusion using pressures from 25 to 60,000 psi, using a Micrometrics® Autopore™ 9500 model (130° contact angle, mercury with a surface tension of 0.480 N/m, and no correction for mercury compression). According to certain embodiments, the porous ceramic media may include a total open porosity content of at least about 0.10 cc/g, such as, at least about 0.11 cc/g or at least about 0.12 cc/g or at least about 0.13 cc/g or at least about 0.14 cc/g or even at least about 0.15 cc/g. According to still other embodiments, the porous ceramic media may include a total open porosity content of not greater than about 0.6 cc/g, such as, not greater than about 0.59 cc/g or not greater than about 0.58 cc/g or not greater than about 0.57 cc/g or not greater than about 0.56 cc/g or not greater than about 0.55 cc/g or not greater than about 0.54 cc/g or not greater than about 0.53 cc/g or not greater than about 0.52 cc/g or not greater than about 0.51 cc/g or not greater than about 0.50 cc/g or not greater than about 0.49 cc/g or not greater than about 0.48 cc/g or not greater than about 0.47 cc/g or not greater than about 0.46 cc/g or not greater than about 0.45 cc/g or not greater than about 0.44 cc/g or not greater than about 0.43 cc/g or not greater than about 0.42 cc/g or not greater than about 0.41 cc/g or even not greater than about 0.40 cc/g. It will be appreciated that the total open porosity content in the porous ceramic media may be any value between, and including, any of values noted above. It will be further appreciated that the total open porosity content in the porous ceramic media may be within a range between, and including, any of the values noted above.

According to yet other embodiments, the porous ceramic media may include a particular nitric acid resistance parameter. For example, the porous ceramic media may include nitric acid resistance parameter of not greater than about 500 ppm, such as, not greater than about 450 ppm or not greater than about 400 ppm or not greater than about 350 ppm or not greater than about 300 ppm or not greater than about 250 ppm or not greater than about 240 ppm or not greater than about 230 ppm or not greater than about 220 ppm or not greater than about 210 ppm or not greater than about 200 ppm or not greater than about 190 ppm or not greater than about 180 ppm or not greater than about 170 ppm or not greater than about 160 ppm or not greater than about 150 ppm or not greater than about 140 ppm or not greater than about 130 ppm or not greater than about 120 ppm or even not greater than about 110 ppm. It will be appreciated that the nitric acid resistance parameter of the porous ceramic media may be any value between, and including, any of values noted above. It will be further appreciated that the nitric acid resistance parameter of the porous ceramic media may be within a range between, and including, any of the values noted above.

According to still other embodiments, the porous ceramic media may include a particular nitric acid weight loss parameter. For example, the porous ceramic media may include a nitric acid weight loss parameter of not greater than about 0.25 wt. %, such as, not greater than about 0.24 wt. % or not greater than about 0.23 wt. % or not greater than about 0.22 wt. % or not greater than about 0.21 wt. % or not greater than about 0.2 wt. % or not greater than about 0.19 wt. % or not greater than about 0.18 wt. % or not greater than about 0.17 wt. % or not greater than about 0.16 wt. % or not greater than about 0.15 wt. % or not greater than about 0.14 wt. % or not greater than about 0.13 wt. % or not greater than about 0.12 wt. % or not greater than about 0.11 wt. % or not greater than about 0.1 wt. % or not greater than about 0.09 wt. % or not greater than about 0.08 wt. % or not greater than about 0.07 wt. % or not greater than about 0.06 wt. % or not greater than about 0.05 wt. % or even substantially no weight loss. It will be appreciated that the nitric acid weight loss parameter of the porous ceramic media may be any value between, and including, any of values noted above. It will be further appreciated that the nitric acid weight loss parameter of the porous ceramic media may be within a range between, and including, any of the values noted above.

According to yet other embodiments, the porous ceramic media may include a particular HCl acid resistance parameter. For example, the porous ceramic media may include HCl acid resistance parameter of not greater than about 500 ppm, such as, not greater than about 450 ppm or not greater than about 400 ppm or not greater than about 350 ppm or not greater than about 300 ppm or not greater than about 250 ppm or not greater than about 240 ppm or not greater than about 230 ppm or not greater than about 220 ppm or not greater than about 210 ppm or not greater than about 200 ppm or not greater than about 190 ppm or not greater than about 180 ppm or not greater than about 170 ppm or not greater than about 160 ppm or not greater than about 150 ppm or not greater than about 140 ppm or not greater than about 130 ppm or not greater than about 120 ppm or even not greater than about 110 ppm. It will be appreciated that the HCl acid resistance parameter of the porous ceramic media may be any value between, and including, any of values noted above. It will be further appreciated that the HCl acid resistance parameter of the porous ceramic media may be within a range between, and including, any of the values noted above.

According to still other embodiments, the porous ceramic media may include a particular HCl acid weight loss parameter. For example, the porous ceramic media may include a HCl acid weight loss parameter of not greater than about 0.25 wt. %, such as, not greater than about 0.24 wt. % or not greater than about 0.23 wt. % or not greater than about 0.22 wt. % or not greater than about 0.21 wt. % or not greater than about 0.2 wt. % or not greater than about 0.19 wt. % or not greater than about 0.18 wt. % or not greater than about 0.17 wt. % or not greater than about 0.16 wt. % or not greater than about 0.15 wt. % or not greater than about 0.14 wt. % or not greater than about 0.13 wt. % or not greater than about 0.12 wt. % or not greater than about 0.11 wt. % or not greater than about 0.1 wt. % or not greater than about 0.09 wt. % or not greater than about 0.08 wt. % or not greater than about 0.07 wt. % or not greater than about 0.06 wt. % or not greater than about 0.05 wt. % or even substantially no weight loss. It will be appreciated that the HCl acid weight loss parameter of the porous ceramic media may be any value between, and including, any of values noted above. It will be further appreciated that the HCl acid weight loss parameter of the porous ceramic media may be within a range between, and including, any of the values noted above.

According to yet other embodiments, the porous ceramic media may be formed from a raw material mixture that may include clay, feldspar, raw perlite, and silicon carbide (SiC).

According to certain embodiments, the clay included in the raw material mixture may be any type of clay mineral generally used in the formation of a ceramic material, such as, for example, a ball clay, a china clay, a fireclay, a kaolin, a kaolinite clay, a common clay, a bentonite clay, a smectite clay, a montmorillonite clay, an illite clay, a attapulgite clay, a stoneware clay, or any combination thereof.

According to certain embodiments, the raw material mixture may include a particular content of clay. For example, the raw material mixture may include a clay content of at least about 20 wt. % as a percentage of the total weight of the raw material mixture, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or even at least about 29 wt. %. According to still other embodiments, the raw material mixture may include a clay content of not greater than about 60 wt. % as a percentage of the total weight of the raw material mixture, such as, not greater than about 59 wt. % or not greater than about 58 wt. % or not greater than about 57 wt. % or not greater than about 56 wt. % or not greater than about 55 wt. % or not greater than about 54 wt. % or not greater than about 53 wt. % or not greater than about 52 wt. % or not greater than about 51 wt. % or not greater than about 50 wt. % or not greater than about 49 wt. % or not greater than about 48 wt. % or not greater than about 47 wt. % or not greater than about 48 wt. % or not greater than about 47 wt. % or not greater than about 46 wt. % or not greater than about 45 wt. % or not greater than about 44 wt. % or even not greater than about 43 wt. %. It will be appreciated that the clay content in the raw material mixture may be any value between, and including, any of values noted above. It will be further appreciated that the clay content in the raw material mixture may be within a range between, and including, any of the values noted above.

According to still other embodiments, the raw material mixture may include a particular content of feldspar. For example, the raw material mixture may include a feldspar content of at least about 10 wt. % as a percentage of the total weight of the raw material mixture, such as, at least about 10.5 wt. % or at least about 11 wt. % or at least about 11.5 wt. % or at least about 12 wt. % or at least about 12.5 wt. % or at least about 13 wt. % or at least about 13.5 wt. % or at least about 14 wt. % or at least about 14.5 wt. % or even at least about 15 wt. %. According to still other embodiments, the raw material mixture may include a feldspar content of not greater than about 30 wt. % as a percentage of the total weight of the raw material mixture, such as, not greater than about 29 wt. % or not greater than about 28 wt. % or not greater than about 27 wt. % or not greater than about 26 wt. % or not greater than about 25 wt. % or not greater than about 24 wt. % or not greater than about 23 wt. % or not greater than about 22 wt. % or not greater than about 21 wt. % or even not greater than about 20 wt. %. It will be appreciated that the feldspar content in the raw material mixture may be any value between, and including, any of values noted above. It will be further appreciated that the feldspar content in the raw material mixture may be within a range between, and including, any of the values noted above.

According to still other embodiments, the raw material mixture may include a particular content of raw perlite. For example, the raw material mixture may include a raw perlite content of at least about 20 wt. % as a percentage of the total weight of the raw material mixture, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or even at least about 35 wt. %. According to still other embodiments, the raw material mixture may include a raw perlite content of not greater than about 50 wt. % as a percentage of the total weight of the raw material mixture, such as, not greater than about 49 wt. % or not greater than about 48 wt. % or not greater than about 47 wt. % or not greater than about 46 wt. % or even not greater than about 45 wt. %. It will be appreciated that the raw perlite content in the raw material mixture may be any value between, and including, any of values noted above. It will be further appreciated that the raw perlite content in the raw material mixture may be within a range between, and including, any of the values noted above.

According to still other embodiments, the raw material mixture may include a particular content of SiC. For example, the raw material mixture may include a SiC content of at least about 0.01 wt. % as a percentage of the total weight of the raw material mixture, such as, at least about 0.02 wt. % or at least about 0.03 wt. % or at least about 0.04 wt. % or even at least about 0.05 wt. %. According to still other embodiments, the raw material mixture may include a SiC content of not greater than about 0.25 wt. % as a percentage of the total weight of the raw material mixture, such as, not greater than about 0.24 wt. % or not greater than about 0.23 wt. % or not greater than about 0.22 wt. % or not greater than about 0.21 wt. % or not greater than about 0.20 wt. % or not greater than about 0.19 wt. % or not greater than about 0.18 wt. % or not greater than about 0.17 wt. % or not greater than about 0.16 wt. % or even not greater than about 0.15 wt. %. It will be appreciated that the SiC content in the raw material mixture may be any value between, and including, any of values noted above. It will be further appreciated that the SiC content in the raw material mixture may be within a range between, and including, any of the values noted above.

According to still other embodiments, the porous ceramic media may be a generally non-spherical media. For purposes of embodiments described herein, a porous ceramic media may be described as a non-spherical media when a majority of the particles of the porous ceramic media have a generally non-spherical shape.

According to still other embodiments, the non-spherical porous ceramic media may have a particular average diameter. For purposes of embodiments described herein, the average diameter of a given sample of non-spherical particles may be measured using calipers to determine the largest diameter of a given particle of the sample. This measurement is repeated for at least 15 particles in the given sample and then the measurements are averaged to determine the average diameter for of the given sample of non-spherical particles. According to particular embodiments, the non-spherical media may have an average diameter of at least about 0.3 mm, such as, at least about 0.4 mm or at least about 0.5 mm or at least about 0.6 mm or at least about 0.7 mm or at least about 0.8 mm or at least about 0.9 mm or at least about 1.0 mm or at least about 3 mm or at least about 5 mm or at least about 8 mm or at least about 10 mm or at least about 13 mm or at least about 15 mm or even at least about 18 mm. According to yet other embodiments, the non-spherical media may have an average diameter of not greater than about 50 mm, such as, not greater than about 48 mm or not greater than about 45 mm or not greater than about 43 mm or not greater than about 40 mm or not greater than about 38 mm or not greater than about 35 mm or not greater than about 33 mm or not greater than about 30 mm or not greater than about 28 mm or not greater than about 25 mm or not greater than about 23 mm or even not greater than about 20 mm. It will be appreciated that the average non-spherical diameter of the spherical media may be any value between, and including, any of values noted above. It will be further appreciated that the average spherical diameter of the non-spherical media may be within a range between, and including, any of the values noted above.

According to yet other embodiments, the porous ceramic media may be a spherical media. For purposes of embodiments described herein, a porous ceramic media may be described as a spherical media when a majority of the particles of the porous ceramic media have a generally spherical shape.

According to still other embodiments, the spherical media of particular embodiments described herein may have a particular average diameter. For purposes of embodiments described herein, the average diameter of a given sample of non-spherical particles may be measured using a Retsch® Camsizer® (“Camsizer”). The Camsizer feeds particles in a vertical downward monolayer in front of high speed cameras to do a diameter measurement from the images. Measurements are determined from the smallest chord of the particle as seen in the images. According to certain embodiments, the spherical media may have an average spherical diameter of at least about 0.3 mm, such as, at least about 0.4 mm or at least about 0.5 mm or at least about 0.6 mm or at least about 0.7 mm or at least about 0.8 mm or at least about 0.9 mm or at least about 1.0 mm or at least about 3 mm or at least about 5 mm or at least about 8 mm or at least about 10 mm or at least about 13 mm or at least about 15 mm or even at least about 18 mm. According to yet other embodiments, the spherical media may have an average spherical diameter of not greater than about 50 mm, such as, not greater than about 48 mm or not greater than about 45 mm or not greater than about 43 mm or not greater than about 40 mm or not greater than about 38 mm or not greater than about 35 mm or not greater than about 33 mm or not greater than about 30 mm or not greater than about 28 mm or not greater than about 25 mm or not greater than about 23 mm or even not greater than about 20 mm. It will be appreciated that the average spherical diameter of the spherical media may be any value between, and including, any of values noted above. It will be further appreciated that the average spherical diameter of the spherical media may be within a range between, and including, any of the values noted above.

According to yet other embodiments, the porous ceramic media formed according to embodiments described herein may be configured for use as a porous functional media. According to still other embodiments described herein, the porous ceramic media formed according to embodiments described herein may have a particular shape configured for use as porous functional media.

According to yet other embodiments, the porous ceramic media formed according to embodiments described herein may be configured for use as a catalyst carrier. According to still other embodiments described herein, the porous ceramic media formed according to embodiments described herein may have a particular shape configured for use as a catalyst carrier.

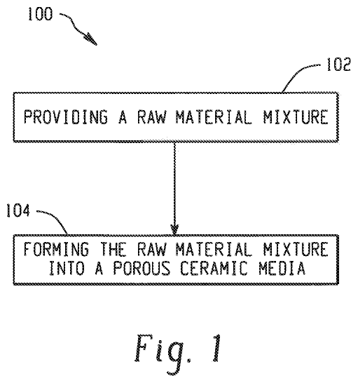

Referring now to a method of forming a porous ceramic media, FIG. 1 illustrates a media forming process 100. Media forming process 100 may include a first step 102 of providing a raw material mixture, and a second step 104 of forming the raw material mixture into a porous ceramic media.

According to particular embodiments, the raw material mixture provided in step 102 may include particular materials. For example, the raw material mixture provided in step 102 may include clay, feldspar, raw perlite, and silicon carbide (SiC).

According to certain embodiments, the clay included in the raw material mixture may be any type of clay mineral generally used in the formation of a ceramic material, such as, for example, a ball clay, a china clay, a fireclay, a kaolin, a kaolinite clay, a common clay, a bentonite clay, a smectite clay, a montmorillonite clay, an illite clay, a attapulgite clay, a stoneware clay, or any combination thereof.

According to certain embodiments, the raw material mixture provided in step 102 may include a particular content of clay. For example, the raw material mixture provided in step 102 may include a clay content of at least about 20 wt. % as a percentage of the total weight of the raw material mixture provided in step 102, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or even at least about 29 wt. %. According to still other embodiments, the raw material mixture provided in step 102 may include a clay content of not greater than about 60 wt. % as a percentage of the total weight of the raw material mixture provided in step 102, such as, not greater than about 59 wt. % or not greater than about 58 wt. % or not greater than about 57 wt. % or not greater than about 56 wt. % or not greater than about 55 wt. % or not greater than about 54 wt. % or not greater than about 53 wt. % or not greater than about 52 wt. % or not greater than about 51 wt. % or not greater than about 50 wt. % or not greater than about 49 wt. % or not greater than about 48 wt. % or not greater than about 47 wt. % or not greater than about 48 wt. % or not greater than about 47 wt. % or not greater than about 46 wt. % or not greater than about 45 wt. % or not greater than about 44 wt. % or even not greater than about 43 wt. %. It will be appreciated that the clay content in the raw material mixture provided in step 102 may be any value between, and including, any of values noted above. It will be further appreciated that the clay content in the raw material mixture provided in step 102 may be within a range between, and including, any of the values noted above.

According to still other embodiments, the raw material mixture provided in step 102 may include a particular content of feldspar. For example, the raw material mixture provided in step 102 may include a feldspar content of at least about 10 wt. % as a percentage of the total weight of the raw material mixture provided in step 102, such as, at least about 10.5 wt. % or at least about 11 wt. % or at least about 11.5 wt. % or at least about 12 wt. % or at least about 12.5 wt. % or at least about 13 wt. % or at least about 13.5 wt. % or at least about 14 wt. % or at least about 14.5 wt. % or even at least about 15 wt. %. According to still other embodiments, the raw material mixture provided in step 102 may include a feldspar content of not greater than about 30 wt. % as a percentage of the total weight of the raw material mixture provided in step 102, such as, not greater than about 29 wt. % or not greater than about 28 wt. % or not greater than about 27 wt. % or not greater than about 26 wt. % or not greater than about 25 wt. % or not greater than about 24 wt. % or not greater than about 23 wt. % or not greater than about 22 wt. % or not greater than about 21 wt. % or even not greater than about 20 wt. %. It will be appreciated that the feldspar content in the raw material mixture provided in step 102 may be any value between, and including, any of values noted above. It will be further appreciated that the feldspar content in the raw material mixture provided in step 102 may be within a range between, and including, any of the values noted above.

According to still other embodiments, the raw material mixture provided in step 102 may include a particular content of raw perlite. For example, the raw material mixture provided in step 102 may include a raw perlite content of at least about 20 wt. % as a percentage of the total weight of the raw material mixture provided in step 102, such as, at least about 21 wt. % or at least about 22 wt. % or at least about 23 wt. % or at least about 24 wt. % or at least about 25 wt. % or at least about 26 wt. % or at least about 27 wt. % or at least about 28 wt. % or at least about 29 wt. % or at least about 30 wt. % or at least about 31 wt. % or at least about 32 wt. % or at least about 33 wt. % or at least about 34 wt. % or even at least about 35 wt. %. According to still other embodiments, the raw material mixture provided in step 102 may include a raw perlite content of not greater than about 50 wt. % as a percentage of the total weight of the raw material mixture provided in step 102, such as, not greater than about 49 wt. % or not greater than about 48 wt. % or not greater than about 47 wt. % or not greater than about 46 wt. % or even not greater than about 45 wt. %. It will be appreciated that the raw perlite content in the raw material mixture provided in step 102 may be any value between, and including, any of values noted above. It will be further appreciated that the raw perlite content in the raw material mixture provided in step 102 may be within a range between, and including, any of the values noted above.

According to still other embodiments, the raw material mixture provided in step 102 may include a particular content of SiC. For example, the raw material mixture provided in step 102 may include a SiC content of at least about 0.01 wt. % as a percentage of the total weight of the raw material mixture provided in step 102, such as, at least about 0.02 wt. % or at least about 0.03 wt. % or at least about 0.04 wt. % or even at least about 0.05 wt. %. According to still other embodiments, the raw material mixture provided in step 102 may include a SiC content of not greater than about 0.25 wt. % as a percentage of the total weight of the raw material mixture provided in step 102, such as, not greater than about 0.24 wt. % or not greater than about 0.23 wt. % or not greater than about 0.22 wt. % or not greater than about 0.21 wt. % or not greater than about 0.20 wt. % or not greater than about 0.19 wt. % or not greater than about 0.18 wt. % or not greater than about 0.17 wt. % or not greater than about 0.16 wt. % or even not greater than about 0.15 wt. %. It will be appreciated that the SiC content in the raw material mixture provided in step 102 may be any value between, and including, any of values noted above. It will be further appreciated that the SiC content in the raw material mixture provided in step 102 may be within a range between, and including, any of the values noted above.

Referring now to step 104 of the media forming process 100, forming of the porous ceramic media may include an extrusion process or a pressing process.

Referring now to the porous ceramic media formed in step 104 of the media forming process 100, the porous ceramic media may include a particular chemical composition, a particular phase composition, a particular total open porosity content, and a particular nitric acid resistance parameter.

Referring to the particular chemical composition, according to certain embodiments, the chemical composition of the porous ceramic media formed in step 104 may include SiO₂, Al₂O₃, an alkali component and a secondary metal oxide component selected from the group consisting of an Fe oxide, a Ti oxide, a Ca oxide, a Mg oxide and combinations thereof.

According to yet other embodiments, the chemical composition of the porous ceramic media formed in step 104 may include a particular content of SiO₂. For example, the porous ceramic media formed in step 104 may include a SiO₂ content of at least about 65.0 wt. % as a percentage of the total weight of the porous ceramic media formed in step 104, such as, at least about 65.5 wt. % or at least about 66.0 wt. % or at least about 66.5 wt. % or at least about 67.0 wt. % or at least about 67.5 wt. % or at least about 68.0 wt. % or at least about 68.5 wt. % or at least about 69.0 wt. % or at least about 69.5 wt. % or even at least about 70 wt. %. According to still other embodiments, the porous ceramic media formed in step 104 may include a SiO₂ content of not greater than about 85 wt. % as a percentage of the total weight of the porous ceramic media formed in step 104, such as, not greater than about 84.5 wt. % or not greater than about 84.0 wt. % or not greater than about 83.5 wt. % or not greater than about 83.0 wt. % or not greater than about 82.5 wt. % or not greater than about 82.0 wt. % or not greater than about 81.5 wt. % or not greater than about 81.0 wt. % or not greater than about 80.5 wt. % or not greater than about 80.0 wt. % or not greater than about 79.5 wt. % or not greater than about 79.0 wt. % or even not greater than about 78.5 wt. %. It will be appreciated that the SiO₂ content in the porous ceramic media formed in step 104 may be any value between, and including, any of values noted above. It will be further appreciated that the SiO₂ content in the porous ceramic media formed in step 104 may be within a range between, and including, any of the values noted above.

According to still other embodiments, the chemical composition of the porous ceramic media formed in step 104 may include a particular content of Al₂O₃. For example, the porous ceramic media formed in step 104 may include an Al₂O₃ content of at least about 10 wt. % as a percentage of the total weight of the porous ceramic media formed in step 104, such as, at least about 10.5 wt. % or at least about 11.0 wt. % or at least about 11.5 wt. % or at least about 12.0 wt. % or at least about 12.5 wt. % or at least about 13.0 wt. % or at least about 13.5 wt. % or even at least about 14 wt. %. According to still other embodiments, the porous ceramic media formed in step 104 may include an Al₂O₃ content of not greater than about 30 wt. % as a percentage of the total weight of the porous ceramic media formed in step 104, such as, not greater than about 29.5 wt. % or not greater than about 29.0 wt. % or not greater than about 28.5 wt. % or not greater than about 28.0 wt. % or not greater than about 27.5 wt. % or not greater than about 27.0 wt. % or not greater than about 26.5 wt. % or not greater than about 26.0 wt. % or not greater than about 25.5 wt. % or not greater than about 25.0 wt. % or not greater than about 24.5 wt. % or not greater than about 24.0 wt. % or not greater than about 23.5 wt. % or not greater than about 23.0 wt. % or even not greater than about 22.5 wt. %. It will be appreciated that the Al₂O₃ content in the porous ceramic media formed in step 104 may be any value between, and including, any of values noted above. It will be further appreciated that the Al₂O₃ content in the porous ceramic media formed in step 104 may be within a range between, and including, any of the values noted above.

According to yet other embodiments, the alkali component of the chemical composition of the porous ceramic media formed in step 104 may include Na₂O. According to other embodiments, the alkali component of the chemical composition of the porous ceramic media formed in step 104 may include K₂O. According to still other embodiments, the alkali component of the chemical composition of the porous ceramic media formed in step 104 may include Li₂O. According to yet other embodiments, the alkali component of the chemical composition of the porous ceramic media formed in step 104 may include an combination of an alkali component selected from the group consisting of Na₂O, K₂O and Li₂O.

According to yet other embodiments, the porous ceramic media formed in step 104 may include a particular total content of the alkali component. For example, the porous ceramic media formed in step 104 may include a alkali component total content of at least about 2.0 wt. % as a percentage of the total weight of the porous ceramic media formed in step 104, such as, at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or even at least about 3.0 wt. %. According to still other embodiments, the porous ceramic media formed in step 104 may include an alkali component total content of not greater than about 8.0 wt. % as a percentage of the total weight of the porous ceramic media formed in step 104 or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or even not greater than about 7.0 wt. %. It will be appreciated that the total content of the alkali component in the porous ceramic media formed in step 104 may be any value between, and including, any of values noted above. It will be further appreciated that the total alkali component content in the porous ceramic media formed in step 104 may be within a range between, and including, any of the values noted above.

According to yet other embodiments, the porous ceramic media formed in step 104 may include a particular content of Na₂O. For example, the porous ceramic media formed in step 104 may include a Na₂O content of at least about 2.0 wt. % as a percentage of the total weight of the porous ceramic media formed in step 104, such as, at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or even at least about 3.0 wt. %. According to still other embodiments, the porous ceramic media formed in step 104 may include a Na₂O content of not greater than about 8.0 wt. % as a percentage of the total weight of the porous ceramic media formed in step 104 or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or even not greater than about 7.0 wt. %. It will be appreciated that the content of Na₂O in the porous ceramic media formed in step 104 may be any value between, and including, any of values noted above. It will be further appreciated that the Na₂O content in the porous ceramic media formed in step 104 may be within a range between, and including, any of the values noted above.

According to yet other embodiments, the porous ceramic media formed in step 104 may include a particular content of K₂O. For example, the porous ceramic media formed in step 104 may include a K₂O content of at least about 2.0 wt. % as a percentage of the total weight of the porous ceramic media formed in step 104, such as, at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or even at least about 3.0 wt. %. According to still other embodiments, the porous ceramic media formed in step 104 may include a K₂O content of not greater than about 8.0 wt. % as a percentage of the total weight of the porous ceramic media formed in step 104 or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or even not greater than about 7.0 wt. %. It will be appreciated that the content of K₂O in the porous ceramic media formed in step 104 may be any value between, and including, any of values noted above. It will be further appreciated that the 120 content in the porous ceramic media formed in step 104 may be within a range between, and including, any of the values noted above.

According to yet other embodiments, the porous ceramic media formed in step 104 may include a particular content of Li₂O. For example, the porous ceramic media formed in step 104 may include a Li₂O content of at least about 2.0 wt. % as a percentage of the total weight of the porous ceramic media formed in step 104, such as, at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or even at least about 3.0 wt. %. According to still other embodiments, the porous ceramic media formed in step 104 may include a Li₂O content of not greater than about 8.0 wt. % as a percentage of the total weight of the porous ceramic media formed in step 104 or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or even not greater than about 7.0 wt. %. It will be appreciated that the content of Li₂O in the porous ceramic media formed in step 104 may be any value between, and including, any of values noted above. It will be further appreciated that the Li₂O content in the porous ceramic media formed in step 104 may be within a range between, and including, any of the values noted above.

According to yet other embodiments, the secondary metal oxide component of the porous ceramic media formed in step 104 may be selected from the group consisting of an Fe oxide, a Ti oxide, a Ca oxide, a Mg oxide and combinations thereof. According to still other embodiments, the secondary metal oxide component of the porous ceramic media formed in step 104 may consist of an Fe oxide. According to still other embodiments, the secondary metal oxide component of the porous ceramic media formed in step 104 may consist of a Ti oxide. According to other embodiments, the secondary metal oxide component of the porous ceramic media formed in step 104 may consist of a Ca oxide. According to yet other embodiments, the secondary metal oxide component of the porous ceramic media formed in step 104 may consist of a Mg oxide.

According to yet other embodiments, the porous ceramic media formed in step 104 may include a particular total content of the secondary metal oxide component. For example, the porous ceramic media formed in step 104 may include a secondary metal oxide component total content of at least about 1.0 wt. % as a percentage of the total weight of the porous ceramic media formed in step 104, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media formed in step 104 may include a secondary metal oxide component total content of not greater than about 5.0 wt. % as a percentage of the total weight of the porous ceramic media formed in step 104 or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the total content of the secondary metal oxide component in the porous ceramic media formed in step 104 may be any value between, and including, any of values noted above. It will be further appreciated that the total content of the secondary metal oxide component in the porous ceramic media formed in step 104 may be within a range between, and including, any of the values noted above.

According to yet other embodiments, the porous ceramic media formed in step 104 may include a particular content of an Fe oxide. For example, the porous ceramic media formed in step 104 may include an Fe oxide content of at least about 1.0 wt. % as a percentage of the total weight of the porous ceramic media formed in step 104, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media formed in step 104 may include an Fe oxide content of not greater than about 5.0 wt. % as a percentage of the total weight of the porous ceramic media formed in step 104 or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the content of Fe oxide in the porous ceramic media formed in step 104 may be any value between, and including, any of values noted above. It will be further appreciated that the content of Fe oxide in the porous ceramic media formed in step 104 may be within a range between, and including, any of the values noted above.

According to yet other embodiments, the porous ceramic media formed in step 104 may include a particular content of a Ti oxide. For example, the porous ceramic media formed in step 104 may include a Ti oxide content of at least about 1.0 wt. % as a percentage of the total weight of the porous ceramic media formed in step 104, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media formed in step 104 may include a Ti oxide content of not greater than about 5.0 wt. % as a percentage of the total weight of the porous ceramic media formed in step 104 or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the content of Ti oxide in the porous ceramic media formed in step 104 may be any value between, and including, any of values noted above. It will be further appreciated that the content of Ti oxide in the porous ceramic media formed in step 104 may be within a range between, and including, any of the values noted above.

According to yet other embodiments, the porous ceramic media formed in step 104 may include a particular content of a Ca oxide. For example, the porous ceramic media formed in step 104 may include a Ca oxide content of at least about 1.0 wt. % as a percentage of the total weight of the porous ceramic media formed in step 104, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media formed in step 104 may include a Ca oxide content of not greater than about 5.0 wt. % as a percentage of the total weight of the porous ceramic media formed in step 104 or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the content of Ca oxide in the porous ceramic media formed in step 104 may be any value between, and including, any of values noted above. It will be further appreciated that the content of Ca oxide in the porous ceramic media formed in step 104 may be within a range between, and including, any of the values noted above.

According to yet other embodiments, the porous ceramic media formed in step 104 may include a particular content of a Mg oxide. For example, the porous ceramic media formed in step 104 may include a Mg oxide content of at least about 1.0 wt. % as a percentage of the total weight of the porous ceramic media formed in step 104, such as, at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or even at least about 2.0 wt. %. According to still other embodiments, the porous ceramic media formed in step 104 may include a Mg oxide content of not greater than about 5.0 wt. % as a percentage of the total weight of the porous ceramic media formed in step 104 or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or even not greater than about 4.0 wt. %. It will be appreciated that the content of Mg oxide in the porous ceramic media formed in step 104 may be any value between, and including, any of values noted above. It will be further appreciated that the content of Mg oxide in the porous ceramic media formed in step 104 may be within a range between, and including, any of the values noted above.

According to still other embodiments, the phase composition of the porous ceramic media formed in step 104 may include an amorphous silicate. According to yet other embodiments, the phase composition of the porous ceramic media formed in step 104 may include quartz. According to still other embodiments, the phase composition of the porous ceramic media formed in step 104 may include mullite. According to other embodiments, the phase composition of the porous ceramic media formed in step 104 may include a combination of an amorphous silicate, quartz or mullite. According to yet other embodiments, the phase composition of the porous ceramic media formed in step 104 may include an amorphous silicate, quartz and mullite.

According to yet other embodiments, the porous ceramic media formed in step 104 may include a particular total open porosity content. Open porosity as described herein is determined by mercury intrusion using pressures from 25 to 60,000 psi, using a Micrometrics Autopore 9500 model (130° contact angle, mercury with a surface tension of 0.480 N/m, and no correction for mercury compression). The resulting measurement is multiplied by the material density or particle density of the material and then multiplied by 100 in order to convert the measurement to volume percent porosity. According to certain embodiments, the porous ceramic media formed in step 104 may include a total open porosity content of at least about 10 vol. % as a percentage of the total volume of the porous ceramic media formed in step 104, such as, at least about 11 vol. % or at least about 12 vol. % or at least about 13 vol. % or at least about 14 vol. % or at least about 15 vol. % or at least about 16 vol. % or at least about 17 vol. % or at least about 18 vol. % or at least about 19 vol. % or at least about 20 vol. % or at least about 21 vol. % or at least about 22 vol. % or at least about 23 vol. % or at least about 24 vol. % or even at least about 25 vol. %. According to still other embodiments, the porous ceramic media formed in step 104 may include a total open porosity content of not greater than about 70 vol. % as a percentage of the total volume of the porous ceramic media formed in step 104, such as, not greater than about 70 vol. % or not greater than about 65 vol. % or not greater than about 60 vol. % or not greater than about 55 vol. % or not greater than about 50 vol. % or not greater than about 45 vol. % or even not greater than about 40 vol. %. It will be appreciated that the total open porosity content in the porous ceramic media formed in step 104 may be any value between, and including, any of values noted above. It will be further appreciated that the total open porosity content in the porous ceramic media formed in step 104 may be within a range between, and including, any of the values noted above.

According to still other embodiments, the porous ceramic media formed in step 104 may include a particular total open porosity content. Open porosity as described herein is determined by mercury intrusion using pressures from 25 to 60,000 psi, using a Micrometrics Autopore 9500 model (130° contact angle, mercury with a surface tension of 0.480 N/m, and no correction for mercury compression). According to certain embodiments, the porous ceramic media formed in step 104 may include a total open porosity content of at least about 0.10 cc/g, such as, at least about 0.11 cc/g or at least about 0.12 cc/g or at least about 0.13 cc/g or at least about 0.14 cc/g or even at least about 0.15 cc/g. According to still other embodiments, the porous ceramic media formed in step 104 may include a total open porosity content of not greater than about 0.6 cc/g, such as, not greater than about 0.59 cc/g or not greater than about 0.58 cc/g or not greater than about 0.57 cc/g or not greater than about 0.56 cc/g or not greater than about 0.55 cc/g or not greater than about 0.54 cc/g or not greater than about 0.53 cc/g or not greater than about 0.52 cc/g or not greater than about 0.51 cc/g or not greater than about 0.50 cc/g or not greater than about 0.49 cc/g or not greater than about 0.48 cc/g or not greater than about 0.47 cc/g or not greater than about 0.46 cc/g or not greater than about 0.45 cc/g or not greater than about 0.44 cc/g or not greater than about 0.43 cc/g or not greater than about 0.42 cc/g or not greater than about 0.41 cc/g or even not greater than about 0.40 cc/g. It will be appreciated that the total open porosity content in the porous ceramic media formed in step 104 may be any value between, and including, any of values noted above. It will be further appreciated that the total open porosity content in the porous ceramic media formed in step 104 may be within a range between, and including, any of the values noted above.

According to yet other embodiments, the porous ceramic media formed in step 104 may include a particular nitric acid resistance parameter. For example, the porous ceramic media formed in step 104 may include nitric acid resistance parameter of not greater than about 500 ppm, such as, not greater than about 450 ppm or not greater than about 400 ppm or not greater than about 350 ppm or not greater than about 300 ppm or not greater than about 250 ppm or not greater than about 240 ppm or not greater than about 230 ppm or not greater than about 220 ppm or not greater than about 210 ppm or not greater than about 200 ppm or not greater than about 190 ppm or not greater than about 180 ppm or not greater than about 170 ppm or not greater than about 160 ppm or not greater than about 150 ppm or not greater than about 140 ppm or not greater than about 130 ppm or not greater than about 120 ppm or even not greater than about 110 ppm. It will be appreciated that the nitric acid resistance parameter of the porous ceramic media formed in step 104 may be any value between, and including, any of values noted above. It will be further appreciated that the nitric acid resistance parameter of the porous ceramic media formed in step 104 may be within a range between, and including, any of the values noted above.

According to still other embodiments, the porous ceramic media formed in step 104 may include a particular nitric acid weight loss parameter. For example, the porous ceramic media formed in step 104 may include a nitric acid weight loss parameter of not greater than about 0.25 wt. %, such as, not greater than about 0.24 wt. % or not greater than about 0.23 wt. % or not greater than about 0.22 wt. % or not greater than about 0.21 wt. % or not greater than about 0.2 wt. % or not greater than about 0.19 wt. % or not greater than about 0.18 wt. % or not greater than about 0.17 wt. % or not greater than about 0.16 wt. % or not greater than about 0.15 wt. % or not greater than about 0.14 wt. % or not greater than about 0.13 wt. % or not greater than about 0.12 wt. % or not greater than about 0.11 wt. % or not greater than about 0.1 wt. % or not greater than about 0.09 wt. % or not greater than about 0.08 wt. % or not greater than about 0.07 wt. % or not greater than about 0.06 wt. % or not greater than about 0.05 wt. % or even substantially no weight loss. It will be appreciated that the nitric acid weight loss parameter of the porous ceramic media formed in step 104 may be any value between, and including, any of values noted above. It will be further appreciated that the nitric acid weight loss parameter of the porous ceramic media formed in step 104 may be within a range between, and including, any of the values noted above.

According to yet other embodiments, the porous ceramic media formed in step 104 may include a particular HCl acid resistance parameter. For example, the porous ceramic media formed in step 104 may include an HCl acid resistance parameter of not greater than about 500 ppm, such as, not greater than about 450 ppm or not greater than about 400 ppm or not greater than about 350 ppm or not greater than about 300 ppm or not greater than about 250 ppm or not greater than about 240 ppm or not greater than about 230 ppm or not greater than about 220 ppm or not greater than about 210 ppm or not greater than about 200 ppm or not greater than about 190 ppm or not greater than about 180 ppm or not greater than about 170 ppm or not greater than about 160 ppm or not greater than about 150 ppm or not greater than about 140 ppm or not greater than about 130 ppm or not greater than about 120 ppm or even not greater than about 110 ppm. It will be appreciated that the HCl acid resistance parameter of the porous ceramic media formed in step 104 may be any value between, and including, any of values noted above. It will be further appreciated that the HCl acid resistance parameter of the porous ceramic media formed in step 104 may be within a range between, and including, any of the values noted above.

According to still other embodiments, the porous ceramic media formed in step 104 may include a particular HCl acid weight loss parameter. For example, the porous ceramic media formed in step 104 may include a HCl acid weight loss parameter of not greater than about 0.25 wt. %, such as, not greater than about 0.24 wt. % or not greater than about 0.23 wt. % or not greater than about 0.22 wt. % or not greater than about 0.21 wt. % or not greater than about 0.2 wt. % or not greater than about 0.19 wt. % or not greater than about 0.18 wt. % or not greater than about 0.17 wt. % or not greater than about 0.16 wt. % or not greater than about 0.15 wt. % or not greater than about 0.14 wt. % or not greater than about 0.13 wt. % or not greater than about 0.12 wt. % or not greater than about 0.11 wt. % or not greater than about 0.1 wt. % or not greater than about 0.09 wt. % or not greater than about 0.08 wt. % or not greater than about 0.07 wt. % or not greater than about 0.06 wt. % or not greater than about 0.05 wt. % or even substantially no weight loss. It will be appreciated that the HCl acid weight loss parameter of the porous ceramic media formed in step 104 may be any value between, and including, any of values noted above. It will be further appreciated that the HCl acid weight loss parameter of the porous ceramic media formed in step 104 may be within a range between, and including, any of the values noted above.

According to still other embodiments, the porous ceramic media formed in step 104 may be a generally non-spherical media. For purposes of embodiments described herein, a porous ceramic media may be described as a non-spherical media when a majority of the particles of the porous ceramic media have a generally non-spherical shape.

According to still other embodiments, the non-spherical porous ceramic media may have a particular average diameter. For purposes of embodiments described herein, the average diameter of a given sample of non-spherical particles may be measured using calipers to determine the largest diameter of a given particle of the sample. This measurement is repeated for at least 15 particles in the given sample and then the measurements are averaged to determine the average diameter for of the given sample of non-spherical particles. According to particular embodiments, the non-spherical media may have an average diameter of at least about 0.3 mm, such as, at least about 0.4 mm or at least about 0.5 mm or at least about 0.6 mm or at least about 0.7 mm or at least about 0.8 mm or at least about 0.9 mm or at least about 1.0 mm or at least about 3 mm or at least about 5 mm or at least about 8 mm or at least about 10 mm or at least about 13 mm or at least about 15 mm or even at least about 18 mm. According to yet other embodiments, the non-spherical media may have an average diameter of not greater than about 50 mm, such as, not greater than about 48 mm or not greater than about 45 mm or not greater than about 43 mm or not greater than about 40 mm or not greater than about 38 mm or not greater than about 35 mm or not greater than about 33 mm or not greater than about 30 mm or not greater than about 28 mm or not greater than about 25 mm or not greater than about 23 mm or even not greater than about 20 mm. It will be appreciated that the average non-spherical diameter of the spherical media may be any value between, and including, any of values noted above. It will be further appreciated that the average spherical diameter of the non-spherical media may be within a range between, and including, any of the values noted above.

According to yet other embodiments, the porous ceramic media formed in step 104 may be a spherical media. For purposes of embodiments described herein, a porous ceramic media may be described as a spherical media when a majority of the particles of the porous ceramic media have a generally spherical shape.

According to still other embodiments, the spherical media of particular embodiments described herein may have a particular average diameter. For purposes of embodiments described herein, the average diameter of a given sample of non-spherical particles may be measured using a Retsch® Camsize® (“Camsizer”). The Camsizer feeds particles in a vertical downward monolayer in front of high speed cameras to do a diameter measurement from the images. Measurements are determined from the smallest chord of the particle as seen in the images. According to certain embodiments, the spherical media may have an average spherical diameter of at least about 0.3 mm, such as, at least about 0.4 mm or at least about 0.5 mm or at least about 0.6 mm or at least about 0.7 mm or at least about 0.8 mm or at least about 0.9 mm or at least about 1.0 mm or at least about 3 mm or at least about 5 mm or at least about 8 mm or at least about 10 mm or at least about 13 mm or at least about 15 mm or even at least about 18 mm. According to yet other embodiments, the spherical media may have an average spherical diameter of not greater than about 50 mm, such as, not greater than about 48 mm or not greater than about 45 mm or not greater than about 43 mm or not greater than about 40 mm or not greater than about 38 mm or not greater than about 35 mm or not greater than about 33 mm or not greater than about 30 mm or not greater than about 28 mm or not greater than about 25 mm or not greater than about 23 mm or even not greater than about 20 mm. It will be appreciated that the average spherical diameter of the spherical media may be any value between, and including, any of values noted above. It will be further appreciated that the average spherical diameter of the spherical media may be within a range between, and including, any of the values noted above.

According to yet other embodiments, the porous ceramic media formed in step 104 formed according to embodiments described herein may be configured for use as a porous functional media. According to still other embodiments described herein, the porous ceramic media formed in step 104 formed according to embodiments described herein may have a particular shape configured for use as porous functional media.

According to yet other embodiments, the porous ceramic media formed in step 104 formed according to embodiments described herein may be configured for use as a catalyst carrier. According to still other embodiments described herein, the porous ceramic media formed in step 104 formed according to embodiments described herein may have a particular shape configured for use as a catalyst carrier.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

A porous ceramic media comprising: a chemical composition comprising SiO₂, Al₂O₃, an alkali component and a secondary metal oxide component selected from the group consisting of an Fe oxide, a Ti oxide, a Ca oxide, a Mg oxide and combinations thereof; a phase composition comprising amorphous silicate, quartz and mullite; a total open porosity content of at least about 10 vol. % and not greater than about 70 vol. % as a percentage of the total volume of the ceramic media, and a nitric acid resistance parameter of not greater than about 500 ppm.

### Embodiment 2

The porous ceramic media of any one of the previous embodiments, wherein the chemical composition comprises: a content of SiO₂ of at least about 65.0 wt. % and not greater than about 85.0 wt. % as a percentage of the total weight of the porous ceramic media; a content of Al₂O₃ of at least about 10 wt. % and not greater than about 30 wt. % as a percentage of the total weight of the porous ceramic media; a content of an alkali component of at least about 2 wt. % and not greater than about 8 wt. % as a percentage of the total weight of the porous ceramic media; and a content of a secondary metal oxide component of at least about 1 wt. % and not greater than about 5 wt. % as a percentage of the total weight of the porous ceramic media.

### Embodiment 3

The porous ceramic media of any one of the previous embodiments, wherein the alkali component comprises Na₂O, K₂O, Li₂O or a combination thereof.

### Embodiment 4

The porous ceramic media of any one of the previous embodiments, wherein the secondary metal oxide component consists of an Fe oxide, consists of a Ti oxide, consists of Ca oxide, consists of a Mg oxide.

### Embodiment 5

The porous ceramic media of any one of the previous embodiments, wherein the chemical composition comprises a content of SiO₂ of at least about 65.0 wt. % as a percentage of the total weight of the porous ceramic media or at least about 65.5 wt. % or at least about 66.0 wt. % or at least about 66.5 wt. % or at least about 67.0 wt. % or at least about 67.5 wt. % or at least about 68.0 wt. % or at least about 68.5 wt. % or at least about 69.0 wt. % or at least about 70 wt. %.

### Embodiment 6

The porous ceramic media of any one of the previous embodiments, wherein the chemical composition comprises a content of SiO₂ of not greater than about 85.0 wt. % as a percentage of the total weight of the porous ceramic media of not greater than about 84.5 wt. % or not greater than about 84.0 wt. % or not greater than about 83.5 wt. % or not greater than about 83.0 wt. % or not greater than about 82.5 wt. % or not greater than about 82.0 wt. % or not greater than about 81.5 wt. % or not greater than about 81.0 wt. % or not greater than about 80.5 wt. % or not greater than about 80.0 wt. % or not greater than about 79.5 wt. % or not greater than about 79.0 wt. % or not greater than about 78.5 wt. %.

### Embodiment 7

The porous ceramic media of any one of the previous embodiments, wherein the chemical composition comprises a content of Al₂O₃ of at least about 10.0 wt. % as a percentage of the total weight of the porous ceramic media or at least about 10.5 wt. % or at least about 11.0 wt. % or at least about 11.5 wt. % or at least about 12.0 wt. % or at least about 12.5 wt. % or at least about 13.0 wt. % or at least about 13.5 wt. % or at least about 14 wt. %.

### Embodiment 8

The porous ceramic media of any one of the previous embodiments, wherein the chemical composition comprises a content of Al₂O₃ of not greater than about 30 wt. % as a percentage of the total weight of the porous ceramic media or not greater than about 29.5 wt. % or not greater than about 29.0 wt. % or not greater than about 28.5 wt. % or not greater than about 28.0 wt. % or not greater than about 27.5 wt. % or not greater than about 27.0 wt. % or not greater than about 26.5 wt. % or not greater than about 26.0 wt. % or not greater than about 25.5 wt. % or not greater than about 25.0 wt. % or not greater than about 24.5 wt. % or not greater than about 24.0 wt. % or not greater than about 23.5 wt. % or not greater than about 23.0 wt. % or not greater than about 22.5 wt. %.

### Embodiment 9

The porous ceramic media of any one of the previous embodiments, wherein the chemical composition comprises a content of an alkali component of at least about 2.0 wt. % as a percentage of the total weight of the porous ceramic media or at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or at least about 3.0 wt. %.

### Embodiment 10

The porous ceramic media of any one of the previous embodiments, wherein the chemical composition comprises a content of an alkali component of not greater than about 8.0 wt. % as a percentage of the total weight of the porous ceramic media or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or not greater than about 7.0 wt. %.

### Embodiment 11

The porous ceramic media of any one of the previous embodiments, wherein the chemical composition comprises a content of a secondary metal oxide component of at least about 1.0 wt. % as a percentage of the total weight of the porous ceramic media or at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or at least about 2.0 wt. %.

### Embodiment 12

The porous ceramic media of any one of the previous embodiments, wherein the chemical composition comprises a content of a secondary metal oxide component of not greater than about 5.0 wt. % as a percentage of the total weight of the porous ceramic media or not greater than about 4.9 wt. % or not greater than about 4.8 wt. % or not greater than about 4.7 wt. % or not greater than about 4.6 wt. % or not greater than about 4.5 wt. % or not greater than about 4.4 wt. % or not greater than about 4.3 wt. % or not greater than about 4.2 wt. % or not greater than about 4.1 wt. % or not greater than about 4.0 wt. %.

### Embodiment 13

The porous ceramic media of any one of the previous embodiments, wherein the media comprises at least about 10 vol. % open porosity as a percentage of the total volume of the porous ceramic media or at least about 11 vol. % or at least about 12 vol. % or at least about 13 vol. % or at least about 14 vol. % or at least about 15 vol. % or at least about 16 vol. % or at least about 17 vol. % or at least about 18 vol. % or at least about 19 vol. % or at least about 20 vol. % or at least about 21 vol. % or at least about 22 vol. % or at least about 23 vol. % or at least about 24 vol. % or at least about 25 vol. %.

### Embodiment 14

The porous ceramic media of any one of the previous embodiments, wherein the media comprises not greater than about 70 vol. % as a percentage of the total volume of the porous ceramic media or not greater than about 65 vol. % or not greater than about 60 vol. % or not greater than about 55 vol. % or not greater than about 50 vol. % or not greater than about 45 vol. % or not greater than about 40 vol. %.

### Embodiment 15

The porous ceramic media of any one of the previous embodiments, wherein the porous ceramic media comprises a nitric acid resistance parameter of not greater than about 500 ppm or not greater than about 450 ppm or not greater than about 400 ppm or not greater than about 350 ppm or not greater than about 300 ppm or not greater than about 250 ppm or not greater than about 240 ppm or not greater than about 230 ppm or not greater than about 220 ppm or not greater than about 210 ppm or not greater than about 200 ppm or not greater than about 190 ppm or not greater than about 180 ppm or not greater than about 170 ppm or not greater than about 160 ppm or not greater than about 150 ppm or not greater than about 140 ppm or not greater than about 130 ppm or not greater than about 120 ppm or not greater than about 110 ppm.

### Embodiment 16

The porous ceramic media of any one of the previous embodiments, wherein the porous ceramic media comprises a nitric acid weight loss parameter of not greater than about 0.25 wt. % or not greater than about 0.24 wt. % or not greater than about 0.23 wt. % or not greater than about 0.22 wt. % or not greater than about 0.21 wt. % or not greater than about 0.2 wt. % or not greater than about 0.19 wt. % or not greater than about 0.18 wt. % or not greater than about 0.17 wt. % or not greater than about 0.16 wt. % or not greater than about 0.15 wt. % or not greater than about 0.14 wt. % or not greater than about 0.13 wt. % or not greater than about 0.12 wt. % or not greater than about 0.11 wt. % or not greater than about 0.1 wt. % or not greater than about 0.09 wt. % or not greater than about 0.08 wt. % or not greater than about 0.07 wt. % or not greater than about 0.06 wt. % or not greater than about 0.05 wt. % or substantially no weight loss.

### Embodiment 17

The porous ceramic media of any one of the previous embodiments, wherein the porous ceramic media comprises a HCl acid resistance parameter of not greater than about 500 ppm or not greater than about 450 ppm or not greater than about 400 ppm or not greater than about 350 ppm or not greater than about 300 ppm or not greater than about 250 ppm or not greater than about 240 ppm or not greater than about 230 ppm or not greater than about 220 ppm or not greater than about 210 ppm or not greater than about 200 ppm or not greater than about 190 ppm or not greater than about 180 ppm or not greater than about 170 ppm or not greater than about 160 ppm or not greater than about 150 ppm or not greater than about 140 ppm or not greater than about 130 ppm or not greater than about 120 ppm or not greater than about 110 ppm.

### Embodiment 18

The porous ceramic media of any one of the previous embodiments, wherein the porous ceramic media comprises a HCl acid weight loss parameter of not greater than about 10 wt. % or not greater than about 9 wt. % or not greater than about 8 wt. % or not greater than about 7 wt. % or not greater than about 6 wt. % or not greater than about 5 wt. % or not greater than about 4 wt. % or not greater than about 3 wt. % or not greater than about 2 wt. % or not greater than about 1 wt. % or not greater than about 0.9 wt. % or not greater than about 0.8 wt. % or not greater than about 0.7 wt. % or not greater than about 0.6 wt. % or not greater than about 0.5 wt. % or not greater than about 0.4 wt. % or not greater than about 0.3 wt. % or not greater than about 0.2 wt. % or not greater than about 0.1 wt. % or substantially weight loss.

### Embodiment 19

The porous ceramic media of any one of the previous embodiments, wherein the porous ceramic media comprises spherical media.

### Embodiment 20

The porous ceramic media of embodiment 19, wherein the spherical media comprises an average diameter of at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 3 mm or at least about 5 mm or at least about 8 mm or at least about 10 mm or at least about 13 mm or at least about 15 mm or at least about 18 mm.

### Embodiment 21

The porous ceramic media of embodiment 19, wherein the spherical media comprises an average diameter of not greater than about 50 mm or not greater than about 48 mm or not greater than about 45 mm or not greater than about 43 mm or not greater than about 40 mm or not greater than about 38 mm or not greater than about 35 mm or not greater than about 33 mm or not greater than about 30 mm or not greater than about 28 mm or not greater than about 25 mm or not greater than about 23 mm or even not greater than about 20 mm.

### Embodiment 22

The porous ceramic media of any one of the previous embodiments, wherein the media comprises a media particular shape configured for use as a catalyst carrier.

### Embodiment 23

The porous ceramic media of any one of the previous embodiments, wherein the media comprises a media particular shape configured for use as a porous functional media.

### Embodiment 24

The porous ceramic media of any one of the previous embodiments, wherein the porous ceramic media is formed from a raw material mixture comprising clay, feldspar, raw perlite, and SiC.

### Embodiment 25

The porous ceramic media of embodiment 24, wherein the raw material mixture comprises a clay content of at least about 20 wt. % as a percentage of the total weight of the raw material mixture.

### Embodiment 26

The porous ceramic media of embodiment 25, wherein the raw material mixture comprises a clay content of not greater than about 60 wt. % as a percentage of the total weight of the raw material mixture.

### Embodiment 27

The porous ceramic media of embodiment 24, wherein the raw material mixture comprises a feldspar content of at least about 10 wt. % as a percentage of the total weight of the raw material mixture.

### Embodiment 28

The porous ceramic media of embodiment 27, wherein the raw material mixture comprises a feldspar content of not greater than about 30 wt. % as a percentage of the total weight of the raw material mixture.

### Embodiment 29

The porous ceramic media of embodiment 24, wherein the raw material mixture comprises a raw perlite content of at least about 20 wt. % as a percentage of the total weight of the raw material mixture.

### Embodiment 30

The porous ceramic media of embodiment 29, wherein the raw material mixture comprises a raw perlite content of not greater than about 50 wt. % as a percentage of the total weight of the raw material mixture.

### Embodiment 31

The porous ceramic media of embodiment 24, wherein the raw material mixture comprises SiC content of at least about 0.05 wt. % as a percentage of the total weight of the raw material mixture.

### Embodiment 32

The porous ceramic media of embodiment 31, wherein the raw material mixture comprises a SiC content of not greater than about 0.25 wt. % as a percentage of the total weight of the raw material mixture.

### Embodiment 33

A method of forming a porous ceramic media, wherein the method comprises: providing a raw material mixture comprising clay, feldspar, raw perlite, and SiC; and forming the raw material mixture into a porous ceramic media, wherein the porous ceramic media comprises: a phase composition comprising amorphous silicate, quartz and mullite; a total porosity content of at least about 0.10 cc/g an not greater than about 0.6 cc/g, and a nitric acid resistance parameter of not greater than about 500 ppm.

### Embodiment 34

The method of embodiment 33, wherein the raw material mixture comprises clay, feldspar, raw perlite, and SiC.

### Embodiment 35

The method of embodiment 34, wherein the raw material mixture comprises a clay content of at least about 20 wt. % as a percentage of the total weight of the raw material mixture.

### Embodiment 36

The method of embodiment 35, wherein the raw material mixture comprises a clay content of not greater than about 60 wt. % as a percentage of the total weight of the raw material mixture.

### Embodiment 37

The method of embodiment 34, wherein the raw material mixture comprises a feldspar content of at least about 10 wt. % as a percentage of the total weight of the raw material mixture.

### Embodiment 38

The method of embodiment 37, wherein the raw material mixture comprises a feldspar content of not greater than about 30 wt. % as a percentage of the total weight of the raw material mixture.

### Embodiment 39

The method of embodiment 34, wherein the raw material mixture comprises a raw perlite content of at least about 20 wt. % as a percentage of the total weight of the raw material mixture.

### Embodiment 40

The method of embodiment 39, wherein the raw material mixture comprises a raw perlite content of not greater than about 50 wt. % as a percentage of the total weight of the raw material mixture.

### Embodiment 41

The method of embodiment 34, wherein the raw material mixture comprises SiC content of at least about 0.05 wt. % as a percentage of the total weight of the raw material mixture.

### Embodiment 42

The method of embodiment 41, wherein the raw material mixture comprises a SiC content of not greater than about 0.25 wt. % as a percentage of the total weight of the raw material mixture.

### Embodiment 43

The method of embodiment 33, wherein porous ceramic media comprises a chemical composition comprising: a content of SiO₂ of at least about 65.0 wt. % and not greater than about 85.0 wt. % as a percentage of the total weight of the porous ceramic media; a content of Al₂O₃ of at least about 10 wt. % and not greater than about 30 wt. % as a percentage of the total weight of the porous ceramic media; a content of an alkali component of at least about 2 wt. % and not greater than about 8 wt. % as a percentage of the total weight of the porous ceramic media; and a content of a secondary metal oxide component of at least about 1 wt. % and not greater than about 5 wt. % as a percentage of the total weight of the porous ceramic media.

### Embodiment 44

The method of embodiment 43, wherein the total alkali component comprises Na₂O, K₂O, Li₂O or a combination thereof.

### Embodiment 45

The method of embodiment 43, wherein the secondary metal oxide component consists of an Fe oxide, consists of a Ti oxide, consists of a Ca oxide, consists of a Mg oxide.

### Embodiment 46

The method of embodiment 43, wherein the chemical composition comprises a content of SiO₂ of at least about 65.0 wt. % as a percentage of the total weight of the porous ceramic media or at least about 65.5 wt. % or at least about 66.0 wt. % or at least about 66.5 wt. % or at least about 67.0 wt. % or at least about 67.5 wt. % or at least about 68.0 wt. % or at least about 68.5 wt. % or at least about 69.0 wt. % or at least about 70%.

### Embodiment 47

The method of embodiment 46, wherein the chemical composition comprises a content of SiO₂ of not greater than about 85.0 wt. % as a percentage of the total weight of the porous ceramic media or not greater than about 84.5 wt. % or not greater than about 84.0 wt. % or not greater than about 83.5 wt. % or not greater than about 83.0 wt. % or not greater than about 82.5 wt. % or not greater than about 82.0 wt. % or not greater than about 81.5 wt. % or not greater than about 81.0 wt. % or not greater than about 80.5 wt. % or not greater than about 80.0 wt. % or not greater than about 79.5 wt. % or not greater than about 79.0 wt. % or not greater than about 78.5 wt. %.

### Embodiment 48

The method of embodiment 43, wherein the chemical composition comprises a content of Al₂O₃ of at least about 10.0 wt. % as a percentage of the total weight of the porous ceramic media or at least about 10.5 wt. % or at least about 11.0 wt. % or at least about 11.5 wt. % or at least about 12.0 wt. % or at least about 12.5 wt. % or at least about 13.0 wt. % or at least about 13.5 wt. % or at least about 14 wt. %.

### Embodiment 49

The method of embodiment 48, wherein the chemical composition comprises a content of Al₂O₃ of not greater than about 30 wt. % as a percentage of the total weight of the porous ceramic media or not greater than about 29.5 wt. % or not greater than about 29.0 wt. % or not greater than about 28.5 wt. % or not greater than about 28.0 wt. % or not greater than about 27.5 wt. % or not greater than about 27.0 wt. % or not greater than about 26.5 wt. % or not greater than about 26.0 wt. % or not greater than about 25.5 wt. % or not greater than about 25.0 wt. % or not greater than about 24.5 wt. % or not greater than about 24.0 wt. % or not greater than about 23.5 wt. % or not greater than about 23.0 wt. % or not greater than about 22.5 wt. %.

### Embodiment 50

The method of embodiment 43, wherein the chemical composition comprises a content of an alkali component of at least about 2.0 wt. % as a percentage of the total weight of the porous ceramic media or at least about 2.1 wt. % or at least about 2.2 wt. % or at least about 2.3 wt. % or at least about 2.4 wt. % or at least about 2.5 wt. % or at least about 2.6 wt. % or at least about 2.7 wt. % or at least about 2.8 wt. % or at least about 2.9 wt. % or at least about 3.0 wt. %.

### Embodiment 51

The method of embodiment 51, wherein the chemical composition comprises a content of an alkali component of not greater than about 8.0 wt. % as a percentage of the total weight of the porous ceramic media or not greater than about 7.9 wt. % or not greater than about 7.8 wt. % or not greater than about 7.7 wt. % or not greater than about 7.6 wt. % or not greater than about 7.5 wt. % or not greater than about 7.4 wt. % or not greater than about 7.3 wt. % or not greater than about 7.2 wt. % or not greater than about 7.1 wt. % or not greater than about 7.0 wt. %.

### Embodiment 52

The method of embodiment 43, wherein the chemical composition comprises a content of a secondary metal oxide component of at least about 1.0 wt. % as a percentage of the total weight of the porous ceramic media or at least about 1.1 wt. % or at least about 1.2 wt. % or at least about 1.3 wt. % or at least about 1.4 wt. % or at least about 1.5 wt. % or at least about 1.6 wt. % or at least about 1.7 wt. % or at least about 1.8 wt. % or at least about 1.9 wt. % or at least about 2.0 wt. %.

### Embodiment 53

The method of embodiment 52, wherein the chemical composition comprises a content of a secondary metal oxide component of at least about 5.0 wt. % as a percentage of the total weight of the porous ceramic media or at least about 4.9 wt. % or at least about 4.8 wt. % or at least about 4.7 wt. % or at least about 4.6 wt. % or at least about 4.5 wt. % or at least about 4.4 wt. % or at least about 4.3 wt. % or at least about 4.2 wt. % or at least about 4.1 wt. % or at least about 4.0 wt. %.

### Embodiment 54

The method of embodiment 43, wherein the media comprises at least about 10 vol. % open porosity as a percentage of the total volume of the porous ceramic media or at least about 11 vol. % or at least about 12 vol. % or at least about 13 vol. % or at least about 14 vol. % or at least about 15 vol. % or at least about 16 vol. % or at least about 17 vol. % or at least about 18 vol. % or at least about 19 vol. % or at least about 20 vol. % or at least about 21 vol. % or at least about 22 vol. % or at least about 23 vol. % or at least about 24 vol. % or at least about 25 vol. %.

### Embodiment 55

The method of embodiment 54, wherein the media comprises not greater than about 70 vol. % as a percentage of the total volume of the porous ceramic media or not greater than about 65 vol. % or not greater than about 60 vol. % or not greater than about 55 vol. % or not greater than about 50 vol. % or not greater than about 45 vol. % or not greater than about 40 vol. %.

### Embodiment 56

The method of embodiment 43, wherein the porous ceramic media comprises a nitric acid resistance parameter of not greater than about 500 ppm or not greater than about 450 ppm or not greater than about 400 ppm or not greater than about 350 ppm or not greater than about 300 ppm or not greater than about 250 ppm or not greater than about 240 ppm or not greater than about 230 ppm or not greater than about 220 ppm or not greater than about 210 ppm or not greater than about 200 ppm or not greater than about 190 ppm or not greater than about 180 ppm or not greater than about 170 ppm or not greater than about 160 ppm or not greater than about 150 ppm or not greater than about 140 ppm or not greater than about 130 ppm or not greater than about 120 ppm or not greater than about 110 ppm.

### Embodiment 57

The method of embodiment 56, wherein the porous ceramic media comprises a nitric acid weight loss parameter of not greater than about 0.25 wt. % or not greater than about 0.24 wt. % or not greater than about 0.23 wt. % or not greater than about 0.22 wt. % or not greater than about 0.21 wt. % or not greater than about 0.2 wt. % or not greater than about 0.19 wt. % or not greater than about 0.18 wt. % or not greater than about 0.17 wt. % or not greater than about 0.16 wt. % or not greater than about 0.15 wt. % or not greater than about 0.14 wt. % or not greater than about 0.13 wt. % or not greater than about 0.12 wt. % or not greater than about 0.11 wt. % or not greater than about 0.1 wt. % or not greater than about 0.09 wt. % or not greater than about 0.08 wt. % or not greater than about 0.07 wt. % or not greater than about 0.06 wt. % or not greater than about 0.05 wt. % or substantially weight loss.

### Embodiment 58

The method of embodiment 43, wherein the porous ceramic media comprises a post nitric acid resistance parameter of not greater than about 80 ppm or not greater than about 75 ppm or not greater than about 70 ppm or not greater than about 65 ppm or not greater than about 60 ppm or not greater than about 55 ppm or not greater than about 50 ppm.

### Embodiment 59

The method of embodiment 58, wherein the porous ceramic media comprises a HCl acid resistance parameter of not greater than about 500 ppm or not greater than about 450 ppm or not greater than about 400 ppm or not greater than about 350 ppm or not greater than about 300 ppm or not greater than about 250 ppm or not greater than about 240 ppm or not greater than about 230 ppm or not greater than about 220 ppm or not greater than about 210 ppm or not greater than about 200 ppm or not greater than about 190 ppm or not greater than about 180 ppm or not greater than about 170 ppm or not greater than about 160 ppm or not greater than about 150 ppm or not greater than about 140 ppm or not greater than about 130 ppm or not greater than about 120 ppm or not greater than about 110 ppm.

### Embodiment 60

The method of embodiment 43, wherein the porous ceramic media comprises a HCl acid weight loss parameter of not greater than about 10 wt. % or not greater than about 9 wt. % or not greater than about 8 wt. % or not greater than about 7 wt. % or not greater than about 6 wt. % or not greater than about 5 wt. % or not greater than about 4 wt. % or not greater than about 3 wt. % or not greater than about 2 wt. % or not greater than about 1 wt. % or not greater than about 0.9 wt. % or not greater than about 0.8 wt. % or not greater than about 0.7 wt. % or not greater than about 0.6 wt. % or not greater than about 0.5 wt. % or not greater than about 0.4 wt. % or not greater than about 0.3 wt. % or not greater than about 0.2 wt. % or not greater than about 0.1 wt. % or substantially weight loss.

### Embodiment 61

The method of embodiment 60, wherein the porous ceramic media comprises a post HCl acid resistance parameter of not greater than about 80 ppm or not greater than about 75 ppm or not greater than about 70 ppm or not greater than about 65 ppm or not greater than about 60 ppm or not greater than about 55 ppm or not greater than about 50 ppm.

### Embodiment 62

The method of any one of the previous embodiments, wherein the porous ceramic media comprises spherical media.

### Embodiment 63

The method of embodiment 62, wherein the spherical media comprises an average diameter of at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 3 mm or at least about 5 mm or at least about 8 mm or at least about 10 mm or at least about 13 mm or at least about 15 mm or even at least about 18 mm.

### Embodiment 64

The method of embodiment 62, wherein the spherical media comprises an average diameter of not greater than about 50 mm or not greater than about 48 mm or not greater than about 45 mm or not greater than about 43 mm or not greater than about 40 mm or not greater than about 38 mm or not greater than about 35 mm or not greater than about 33 mm or not greater than about 30 mm or not greater than about 28 mm or not greater than about 25 mm or not greater than about 23 mm or even not greater than about 20.

### Embodiment 65

The method of any one of the previous embodiments, wherein the media comprises a media particular shape configured for use as a catalyst carrier.

### Embodiment 66

The method of any one of the previous embodiments, wherein the media comprises a media particular shape configured for use as a porous functional media.

### EXAMPLES

The concepts described herein will be further described in the following Examples, which do not limit the scope of the invention described in the claims.

### Example 1

Sixteen porous ceramic media samples S1-S16 were prepared according to embodiments described herein.

Porous ceramic media sample S1 was formed by preparing a four-component batch mix of ceramic raw materials in a high-intensity mixer. The batch mix for porous ceramic media sample S1 included 1720 grams of a Tennessee ball clay, 1680 grams of raw perlite, 600 grams of finely ground feldspar powder, and 4 grams of an 1800 grit silicon carbide powder. The batch was thoroughly mixed, then 500 grams of water was added and the batch was mixed for another 3 minutes. The batch was then removed from the mixer, passed through an 8 mesh screen and measured for moisture content. The sub-8-mesh semi-wet material was then fed into a rotating sphere-pressing machine. The resulting spheres were then collected and dried at 90° C. until less than 1% moisture remained. The dry spheres were placed in a quartz sagger and heated to 1240° C. for a 3 hour soak time.

Porous ceramic media sample S2 was formed by preparing a five component batch mix of ceramic raw materials in a high-intensity mixer. The batch mix for porous ceramic media sample S2 included 1600 grams of a Tennessee ball clay, 1400 grams of raw perlite, 600 grams of finely ground feldspar powder, 4 grams of an 1800 grit silicon carbide powder, and 400 grams of a high surface area (>750 m2/g) amorphous silica. The batch was thoroughly mixed, then 575 grams of water was added and the batch was mixed another 3 minutes. The batch was then removed from the mixer, passed through a 14 mesh screen and measured for moisture content. The sub-14-mesh semi-wet material was then fed into a rotating sphere-pressing machine. The resulting spheres were collected and dried at 90° C. until less than 1% moisture remained. The dry spheres were placed in a quartz sagger and heated to 1240° C. for a 3 hour soak time.

Porous ceramic media sample S3 was formed by preparing a five component batch mix of ceramic raw materials in a high-intensity mixer. The batch mix for porous ceramic media sample S3 included 1200 grams of a Tennessee ball clay, 1600 grams of raw perlite, 800 grams of finely ground feldspar powder, 4 grams of an 1800 grit silicon carbide powder, and 400 grams of a high surface area (>200 m2/g) amorphous silica. The batch was thoroughly mixed, then 1000 grams of water was added and the batch was mixed for another 3 minutes. The batch was then removed from the mixer, passed through a 12 mesh screen and measured for moisture content. The sub-12-mesh semi-wet material was then fed into a rotating sphere-pressing machine. The resulting spheres were collected and dried at 90° C. until less than 1% moisture remained. The dry spheres were placed in a quartz sagger and heated to 1240° C. for a 3 hour soak time.

Porous ceramic media sample S4 was formed by preparing a five component batch mix of ceramic raw materials in a high-intensity mixer. The batch mix for porous ceramic media sample S4 included the same materials and weights of each raw material described in sample porous ceramic media S3 above. The batch was thoroughly mixed, then 1175 grams of water was added and the batch was mixed for another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 1170° C. for a 3 hour soak time.

Porous ceramic media sample S5 was formed by preparing a five-component batch mix of ceramic raw materials in a high-intensity mixer. The batch mix for porous ceramic media sample S5 included 1200 grams of a Tennessee ball clay, 200 grams of the Mississippi ball clay, 1800 grams of raw perlite, 800 grams of finely ground feldspar powder, and 4 grams of an 1800 grit silicon carbide powder. The batch was thoroughly mixed, then 530 grams of water was added and the batch was mixed for another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 1170° C. for a 3 hour soak time.

Porous ceramic media sample S6 was formed by preparing a five-component batch mix of ceramic raw materials in a high-intensity mixer. The batch mix for sample porous ceramic media S6 included 1305 grams of the Clay #2 German clay, 900 grams of the 160 surface area silica #1, 1800 grams of raw perlite, 495 grams of finely ground feldspar powder, and 2.25 grams of an 1800 grit silicon carbide powder. The batch was thoroughly mixed, then 1950 grams of water was added and the batch was mixed for another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 1170° C. for a 3 hour soak time.

Porous ceramic media sample S7 was formed by preparing a five-component batch mix of ceramic raw materials in a high-intensity mixer. The batch mix for porous ceramic media sample S7 included 960 grams of the Clay #2 German clay, 900 grams of the 160 surface area silica #1, 750 grams of raw perlite, 390 grams of finely ground feldspar powder, and 1.5 grams of an 1800 grit silicon carbide powder, and 36 grams of a starch binder. The batch was thoroughly mixed, then 1736 grams of water was added and the batch was mixed for another 3 minutes. The batch was removed from the mixer and fed into a rotating press. The resulting spheres were collected and dried at 90° C. until less than 1% moisture remained. The dry spheres were placed in a quartz sagger and heated to 1215° C. for a 3 hour soak time.

Porous ceramic media sample S8 was formed by preparing a four-component batch mix of ceramic raw materials in a high-intensity mixer. The batch mix for porous ceramic media sample S8 included 1200 grams of a natural clay, 1260 grams of raw perlite, 540 grams of finely ground feldspar powder, and 3 grams of an 1800 grit silicon carbide powder. The batch was thoroughly mixed, then 350 grams water was added and the batch was mixed for another 3 minutes. The batch was removed from the mixer and fed into a rotating press. The resulting spheres were collected and dried at 90° C. until less than 1% moisture remained. The dry spheres were placed in a quartz sagger and heated to 1150° C. for a 3 hour soak time.

Porous ceramic media sample S9 was formed by preparing a four-component batch mix of ceramic raw materials in a high-intensity mixer. The batch mix for porous ceramic media sample S9 included 1500 grams of a natural clay, 1200 grams of raw perlite, 300 grams of finely ground feldspar powder, and 3 grams of an 1800 grit silicon carbide powder. The batch was thoroughly mixed, then 350 grams water was added and the batch was mixed for another 3 minutes. The batch was removed from the mixer and fed into a rotating press. The resulting spheres were collected and dried at 90° C. until less than 1% moisture remained. The dry spheres were placed in a quartz sagger and heated to 1150° C. for a 3 hour soak time.

Porous ceramic media sample S10 was formed by preparing a four-component batch mix of ceramic raw materials in a high-intensity mixer. The batch mix for porous ceramic media sample S10 included 900 grams of a natural clay, 1500 grams of raw perlite, 600 grams of finely ground feldspar powder, and 3 grams of an 1800 grit silicon carbide powder. The batch was thoroughly mixed, then 491 grams water was added and the batch was mixed for another 3 minutes. The batch was removed from the mixer and fed into a rotating press. The resulting spheres were collected and dried at 90° C. until less than 1% moisture remained. The dry spheres were placed in a quartz sagger and heated to 1150° C. for a 3 hour soak time.

Porous ceramic media sample S11 was formed by preparing a four-component batch mix of ceramic raw materials in a high-intensity mixer. The batch mix for porous ceramic media sample S11 included 1050 grams of a natural clay, 1350 grams of raw perlite, 600 grams of finely ground feldspar powder, and 3 grams of an 1800 grit silicon carbide powder. The batch was thoroughly mixed, then 318 grams water was added and the batch was mixed for another 3 minutes. The batch was removed from the mixer and fed into a rotating press. The resulting spheres were collected and dried at 90° C. until less than 1% moisture remained. The dry spheres were placed in a quartz sagger and heated to 1150° C. for a 3 hour soak time.

Porous ceramic media sample S12 was formed by preparing a four-component mix of ceramic raw materials in a high-intensity mixer. The batch mix for sample porous ceramic media S12 included 30 lbs of a natural clay, 24 lbs of raw perlite, 6 lbs of finely ground feldspar powder, and 28 grams of an 1800 grit silicon carbide powder. The dry batch was thoroughly mixed and then 10 lbs water was added and the batch was mixed another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 1150° C. for a 3 hour soak time.

Porous ceramic media sample S13 was formed by preparing a four-component mix of ceramic raw materials in a high-intensity mixer. The batch mix for porous ceramic media sample S13 included 30 lbs of a natural clay, 24 lbs of raw perlite, 6 lbs of finely ground feldspar powder, and 28 grams of an 1800 grit silicon carbide powder. The dry batch was thoroughly mixed and then 10 lbs water was added and the batch was mixed another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 1130° C. for a 3 hour soak time.

Porous ceramic media sample S14 was formed by preparing a four-component mix of ceramic raw materials in a high-intensity mixer. The batch mix for sample porous ceramic media sample S14 included 30 lbs of a natural clay, 24 lbs of raw perlite, 6 lbs of finely ground feldspar powder, and 28 grams of an 1800 grit silicon carbide powder. The batch was thoroughly mixed, then 9 lbs water was added and the batch was mixed another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 1150° C. for a 3 hour soak time.

Porous ceramic media sample S15 was formed by preparing a five-component batch mix of ceramic raw materials in a high-intensity mixer. The batch mix for porous ceramic media sample S15 included 16 lbs of a natural clay, 12.5 lbs of raw perlite, 6.5 lbs of finely ground feldspar powder, 15 lbs of a silica with about 160 m2/g surface area, and 11.4 grams of an 1800 grit silicon carbide powder. The batch was thoroughly mixed, then 16.9 lbs water was added and the batch was mixed another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 1200° C. for a 3 hour soak time.

Porous ceramic media sample S16 was formed by preparing a five-component batch mix of ceramic raw materials in a high-intensity mixer. The batch mix for porous ceramic media sample S16 included 16 lbs of a natural clay, 12.5 lbs of raw perlite, 6.5 lbs of finely ground feldspar powder, 15 lbs of a silica with about 160 m2/g surface area, and 11.4 grams of an 1800 grit silicon carbide powder. The batch was thoroughly mixed, then 16.9 lbs water was added and the batch was mixed another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 1250 for a 3 hour soak time.

The compositions of the raw material batch mixtures for each of samples S1-S16 are summarized in Table 1 below. Raw material component contents are recorder in wt. % as a percentage of the total weight of the raw material mixture used to form the sample porous ceramic media.

TABLE 1
Raw Material Compositions for Samples S1-S16

| | | Raw Material Components (wt. %) | | | | |
|---|---|---|---|---|---|---|
| Sample | Natural | | Raw | | | |
| # | Clay | Feldspar | Perlite | Fine SiC | Silica | Total |
| S1 | 43 | 15 | 42 | 0.1 | 0 | 100.1 |
| S2 | 40 | 15 | 35 | 0.1 | 10 | 100.1 |
| S3 | 30 | 20 | 40 | 0.1 | 10 | 100.1 |
| S4 | 30 | 20 | 40 | 0.1 | 10 | 100.1 |
| S5 | 35 | 20 | 45 | 0.1 | 0 | 100.1 |
| S6 | 29 | 11 | 40 | 0.05 | 20 | 100.05 |
| S7 | 32 | 13 | 25 | 0.05 | 30 | 100.05 |
| S8 | 40 | 18 | 42 | 0.1 | 0 | 100.1 |
| S9 | 50 | 10 | 40 | 0.1 | 0 | 100.1 |
| S10 | 30 | 20 | 50 | 0.1 | 0 | 100.1 |
| S11 | 35 | 20 | 45 | 0.1 | 0 | 100.1 |
| S12 | 50 | 10 | 40 | 0.1 | 0 | 100.1 |
| S13 | 50 | 10 | 40 | 0.1 | 0 | 100.1 |
| S14 | 50 | 10 | 40 | 0.1 | 0 | 100.1 |
| S15 | 32 | 13 | 25 | 0.05 | 30 | 100.05 |
| S16 | 32 | 13 | 25 | 0.05 | 30 | 100.05 |

The chemical compositions of the finally formed samples S1-S16 are summarized in Table 2 below. Chemical component contents are recorder as wt. % as a percentage of the total weight of the finally formed sample porous ceramic media.

TABLE 2
Final Product Chemical Composition for Samples S1-S16

| Sample | Final Product Chemical Composition Components (wt. %) | | | | | | | | |
|---|---|---|---|---|---|---|---|---|---|
| # | SiO₂ | Al₂O₃ | Fe₂O₃ | TiO₂ | CaO | MgO | Na₂O | K₂O | Total |
| S1 | 70.9 | 22 | 0.8 | 0.9 | 0.5 | 0 | 2.4 | 2.5 | 100 |
| S2 | 73.5 | 20 | 0.7 | 0.8 | 0.5 | 0 | 2.2 | 2.2 | 99.9 |
| S3 | 74.4 | 18.4 | 0.6 | 0.6 | 0.5 | 0 | 2.6 | 2.6 | 99.7 |
| S4 | 74.4 | 18.4 | 0.6 | 0.6 | 0.5 | 0 | 2.6 | 2.6 | 99.7 |
| S5 | 71.2 | 20.8 | 0.7 | 0.7 | 0.6 | 0 | 2.9 | 3 | 99.9 |
| S6 | 78.5 | 14.3 | 0.7 | 0 | 0.4 | 0.1 | 2.4 | 3 | 99.4 |
| S7 | 79.82 | 13.97 | 0.67 | 0.45 | 0.39 | 0.13 | 1.97 | 2.48 | 99.88 |
| S8 | n/a | n/a | n/a | n/a | n/a | n/a | n/a | n/a | — |
| S9 | 72.8 | 19.2 | 1.1 | 0.6 | 0.5 | 0.2 | 2.2 | 3.4 | 100 |
| S10 | n/a | n/a | n/a | n/a | n/a | n/a | n/a | n/a | — |
| S11 | 71.2 | 20.8 | 0.7 | 0.7 | 0.6 | 0 | 2.9 | 3 | 99.9 |
| S12 | 73.2 | 18.9 | 1.1 | 0.7 | 0.5 | 0.1 | 2 | 3.3 | 99.8 |
| S13 | 73.2 | 18.9 | 1.1 | 0.7 | 0.5 | 0.1 | 2 | 3.3 | 99.8 |
| S14 | 72.8 | 19.2 | 1.1 | 0.6 | 0.5 | 0.2 | 2.2 | 3.4 | 100 |
| S15 | 79.56 | 14.34 | 0.74 | 0.49 | 0.36 | 0.15 | 1.83 | 2.43 | 99.9 |
| S16 | 79.56 | 14.34 | 0.74 | 0.49 | 0.36 | 0.15 | 1.83 | 2.43 | 99.9 |

The phase compositions of the finally formed samples S1-S16 are summarized in Table 3 below. Phase components are recorder as whether they are “present” or “NONE” in the finally formed sample porous ceramic media.

TABLE 3
Final Product Phase Composition for Samples S1-S16

| | Final Product Phase Composition Components (wt. %) | | |
|---|---|---|---|
| Sample # | Amorphous Silicate | Crystalline Silica | Mullite |
| S1 | present | present | present |
| S2 | present | present | present |
| S3 | present | present | present |
| S4 | present | present | present |
| S5 | present | present | present |
| S6 | present | present | present |
| S7 | present | present | present |
| S8 | present | present | present |
| S9 | present | present | present |
| S10 | present | present | present |
| S11 | present | present | present |
| S12 | present | present | present |
| S13 | present | present | present |
| S14 | present | present | present |
| S15 | present | present | present |
| S16 | present | present | present |

The physical properties of the finally formed samples S1-S16 are summarized in Table 4 below.

TABLE 4
Physical Properties for Samples S1-S16

| | Physical Properties | | | | | |
|---|---|---|---|---|---|---|
| | | | | Total | | |
| | | | Average | Open | | Specific |
| | Piece | Average | Crush | Pore | Water | Surface |
| Sample | Density | Diameter | Strength | Volume | Absorption | Area |
| # | (g/cc) | (mm) | (lbs) | (cc/g) | (wt. %) | (m²/g) |
| S1 | 1.45 | 5.33 | 87 | 0.24 | n/a | 0.7 |
| S2 | 1.59 | 5.12 | 115 | 0.17 | n/a | 1.5 |
| S3 | 1.23 | 5.29 | 98 | 0.37 | 20.8 | 0.2 |
| S4 | 1.03 | 7.89 | 181 | n/a | 27.07 | 0.17 |
| S5 | 1.37 | 9.12 | n/a | 0.28 | 13.2 | 0.13 |
| S6 | 1.27 | 8.10 | 105 | 0.24 | 3.8 | 0.08 |
| S7 | 1.03 | 5.01 | 41.1 | 0.35 | 31.72 | 0.19 |
| S8 | 1.28 | 5.81 | 104 | 0.27 | 20.8 | n/a |
| S9 | 1.45 | 5.56 | 112 | 0.17 | 13.25 | n/a |
| S10 | 1.33 | n/a | 67.9 | 0.28 | 20.27 | n/a |
| S11 | 1.51 | n/a | 63.6 | 0.14 | 14.49 | n/a |
| S12 | 1.73 | 6.95 | 272 | 0.14 | 7.49 | n/a |
| S13 | 2.02 | 6.50 | 288 | 0.07 | n/a | n/a |
| S14 | 1.73 | 5.39 | 125 | 0.19 | n/a | n/a |
| S15 | 1.73 | 4.59 | 81 | 0.1 | n/a | n/a |
| S16 | n/a | n/a | n/a | 0.52 | n/a | n/a |

The finally formed samples S1-S16 were tested to determine their nitric acid resistance parameters and nitric acid weight loss parameters according to the tests described herein. This finally formed sample S1-S16 all showed a nitric acid weight loss parameter of zero or no weight loss. The elemental analysis from the tests of each finally formed sample S1-S16 along with the final nitric acid resistance parameter are summarized in Table 5 below. A listing of zero indicates that the amount of the respective element leached was below the detection limit for ICP for all elements.

TABLE 5
Nitric Acid Resistance Data for Samples S1-S16

| | Leached Components (ppm) | | | | | | | |
|---|---|---|---|---|---|---|---|---|
| | | | | | | | | Nitric Acid |
| | | | | | | | | Resistance |
| Sample | | | | | | | | Parameter |
| # | Si | Al | Fe | Ca | Mg | Na | K | (sum of ppm) |
| S1 | 0 | 0 | 0 | 2 | 0 | 15 | 0 | 17 |
| S2 | 0 | 0 | 0 | 3 | 0 | 12 | 0 | 15 |
| S3 | 0 | 35 | 0 | 3 | 0 | 12 | 3 | 53 |
| S4 | 0 | 0 | 0 | 0 | 0 | 30 | 0 | 30 |
| S5 | 0 | 0 | 0 | 0 | 0 | 6 | 0 | 6 |
| S6 | 15 | 37 | 0 | 12 | 0 | 0 | 0 | 64 |
| S7 | 0 | 0 | 0 | 3 | 0 | 23 | 3 | 29 |
| S8 | 7 | 38 | 2 | 5 | 0 | 23 | 9 | 84 |
| S9 | 5 | 22 | 2 | 4 | 0 | 23 | 11 | 67 |
| S10 | 9 | 32 | 2 | 10 | 0 | 36 | 14 | 103 |
| S11 | 11 | 29 | 2 | 11 | 0 | 35 | 15 | 103 |
| S12 | 0 | 11 | 1 | 2 | 0 | 8 | 3 | 25 |
| S13 | 0 | 0 | 0 | 3 | 0 | 13 | 0 | 16 |
| S14 | 5 | 42 | 0 | 4 | 0 | 14 | 5 | 70 |
| S15 | 8 | 37 | 0 | 21 | 0 | 8 | 0 | 74 |
| S16 | 0 | 44 | 0 | 1 | 0 | 8 | 0 | 53 |

The finally formed samples S1, S5, S7, and S8 were tested to determine their nitric acid resistance parameters and nitric acid weight loss parameters according to the tests described herein. This finally formed sample S1, S5, S7, and S8 all showed a HCl acid weight loss parameter of zero or no weight loss. The elemental analysis from the tests of each finally formed sample S1, S5, S7, and S8 along with the final HCl acid resistance parameter are summarized in Table 6 below. A listing of zero indicates that the amount of the respective element leached was below the detection limit for ICP for all elements.

TABLE 6
HCl Acid Resistance Data for Samples S1, S5, S7, and S8

| | Leached Components (ppm) | | | | | | | |
|---|---|---|---|---|---|---|---|---|
| | | | | | | | | HCL Acid |
| | | | | | | | | Resistance |
| Sample | | | | | | | | Parameter |
| # | Si | Al | Fe | Ca | Mg | Na | K | (sum of ppm) |
| S1 | 24 | 14 | 6 | 2 | 0 | 24 | 7 | 77 |
| S5 | 18 | 16 | 6 | 1 | 0 | 25 | 5 | 71 |
| S7 | 39 | 38 | 11 | 10 | 0 | 37 | 10 | 145 |
| S8 | 56 | 57 | 11 | 12 | 0 | 52 | 21 | 209 |

### Example 2

Six comparative samples CS1-CS6 were prepared for comparison to samples formed according to embodiments described herein.

Comparative sample CS1 was formed by preparing a four-component batch mix of ceramic raw materials in a high-intensity mixer. The batch mix for comparative sample CS1 included 30 lbs of a natural clay, 24 lbs of raw perlite, 6 lbs of finely ground feldspar powder, and 28 grams of an 1800 grit silicon carbide powder. The batch was thoroughly mixed, then 10 lbs water was added and the batch was then mixed for another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 950° C. for a 3 hour soak time.

Comparative sample CS2 was formed by preparing a four-component batch mix of ceramic raw materials in a high-intensity mixer. The batch mix for comparative sample CS2 included 30 lbs of a natural clay, 24 lbs of raw perlite, 6 lbs of finely ground feldspar powder, and 28 grams of an 1800 grit silicon carbide powder. The batch was thoroughly mixed, then 10 lbs water was added and the batch was then mixed for another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 900° C. for a 3 hour soak time.

Comparative sample CS3 was formed by preparing a four-component batch mix of ceramic raw materials in a high-intensity mixer. The batch mix for comparative sample CS3 included 600 grams of a natural clay, 800 grams of raw perlite, 400 grams of finely ground feldspar powder, and 200 grams of amorphous silica. The batch was thoroughly mixed, then 600 grams of water was added and the batch was then mixed for another 3 minutes. The batch was removed from the mixer, extruded through a die, cut to form cylindrical pellets, rounded in a rotating drum and then the resulting spheres were collected and dried at 90° C. until less than 1% moisture remained. The dry spheres were placed in a quartz sagger and heated to 950° C. for a 3 hour soak time.

Comparative sample CS4 was formed by preparing a four-component batch mix of ceramic raw materials in a high-intensity mixer. The batch mix for comparative sample CS4 included 1600 grams of natural clay, 1000 grams of finely ground feldspar powder, 1400 grams of the amorphous silica, and 4 grams of the fine SiC powder. The batch was thoroughly mixed, then 2950 grams of water was added and the batch was mixed another 3 minutes. The batch was then removed from the mixer, passed through an 8 mesh screen and measured for moisture content. The sub-8-mesh semi-wet material was then fed into a rotating sphere-pressing machine. The resulting spheres were then collected and dried at 90° C. until less than 1% moisture remained. The dry spheres were placed in a quartz sagger and heated to 1050° C. for a 3 hour soak time.

Comparative sample CS5 was formed by preparing a four-component batch mix of ceramic raw materials in a high-intensity mixer. The batch mix for comparative sample CS5 included 1600 grams of natural clay, 1000 grams of finely ground feldspar powder, 1400 grams of the amorphous silica, and 4 grams of the fine SiC powder. The batch was thoroughly mixed, then 2950 grams of water was added and the batch was mixed another 3 minutes. The batch was then removed from the mixer, passed through an 8 mesh screen and measured for moisture content. The sub-8-mesh semi-wet material was fed into a rotating sphere-pressing machine. The resulting spheres were collected and dried at 90° C. until less than 1% moisture remained. The dry spheres were placed in a quartz sagger and heated to 1000° C. for a 3 hour soak time.

Comparative sample CS6 was a commercial catalyst carrier having a similar pore volume and chemical analysis to the a porous ceramic material formed according to embodiments described herein, but having been made from different raw materials and thus, having a different phase composition.

The chemical compositions of the finally formed comparative samples CS1-CS6 are summarized in Table 7 below. Chemical component contents are recorder as wt. % as a percentage of the total weight of the finally formed sample porous ceramic media.

TABLE 7
Final Product Chemical Composition for Comparative Samples CS1-CS6

| Sample | Final Product Chemical Composition Components (wt. %) | | | | | | | | |
|---|---|---|---|---|---|---|---|---|---|
| # | SiO₂ | Al₂O₃ | Fe₂O₃ | TiO₂ | CaO | MgO | Na₂O | K₂O | Total |
| CS-1 | 73.2 | 18.9 | 1.1 | 0.7 | 0.5 | 0.1 | 2 | 3.3 | 99.8 |
| CS-2 | 73.2 | 18.9 | 1.1 | 0.7 | 0.5 | 0.1 | 2 | 3.3 | 99.8 |
| CS-3 | 74.4 | 18.4 | 0.6 | 0.6 | 0.5 | 0 | 2.6 | 2.6 | 99.7 |
| CS-4 | 78.2 | 17 | 0.5 | 0.9 | 0.4 | 0 | 1.8 | 1.2 | 100 |
| CS-5 | 78.2 | 17 | 0.5 | 0.9 | 0.4 | 0 | 1.8 | 1.2 | 100 |
| CS-6 | 74.5 | 25.2 | 0.01 | 0.04 | 0 | 0 | 0.07 | 0 | 99.82 |

The phase compositions of the finally formed comparative samples CS1-CS6 are summarized in Table 8 below. Phase components are recorder as whether they are “present” or “NONE” in the finally formed sample porous ceramic media.

TABLE 8
Final Product Phase Composition for Comparative Samples CS1-CS6

| | Final Product Phase Composition Components (wt. %) | | | |
|---|---|---|---|---|
| | Amorphous | Crystalline | | |
| Sample # | Silicate | Silica | Mullite | Albite |
| CS-1 | present | present | NONE | present |
| CS-2 | present | present | NONE | present |
| CS-3 | present | present | NONE | present |
| CS-4 | present | present | NONE | present |
| CS-5 | present | present | NONE | present |
| CS-6 | present | NONE | NONE | NONE |

As shown in Table 8, none of the comparative samples CS1-CS6 showed a combination of the amorphous silicate phase, the crystalline silica phase and the mullite phase (i.e., the combination of phase components shown in all of the porous ceramic media sample S1-S16 formed according to embodiments described herein).

The physical properties of the finally formed comparative samples CS1-CS6 are summarized in Table 9 below.

TABLE 9
Physical Properties for Comparative Samples CS1-CS6

| | Physical Properties | | | | | |
|---|---|---|---|---|---|---|
| | | | | Total | | |
| | | | Average | Open | | Specific |
| | Piece | Average | Crush | Pore | Water | Surface |
| Sample | Density | Diameter | Strength | Volume | Absorption | Area |
| # | (g/cc) | (mm) | (lbs) | (cc/g) | (wt. %) | (m²/g) |
| CS-1 | 1.90 | 6.66 | 61.2 | 0.12 | 11.75 | n/a |
| CS-2 | 1.84 | 6.34 | 35 | 0.13 | 12.8 | n/a |
| CS-3 | 1.54 | 7.14 | 16.3 | 0.24 | 24.42 | 15.5 |
| CS-4 | 1.27 | 4.35 | 27 | 0.36 | n/a | 24.2 |
| CS-5 | 0.99 | 4.74 | 11 | 0.59 | n/a | 41 |
| CS-6 | 0.93 | 3.00 | 12.8 | 0.53 | 65.27 | 239 |

The finally formed comparative samples CS1-CS6 were tested to determine their nitric acid resistance parameters and nitric acid weight loss parameters according to the tests described herein. The nitric acid weight loss parameter and elemental analysis from the tests of each finally formed comparative sample CS1-CS6 along with the final nitric acid resistance parameter are summarized in Table 10 below.

TABLE 10
Nitric Acid Resistance/Weight Loss Data for Comparative Samples CS1-CS6

| | Leached Components (ppm) | | | | | | | | |
|---|---|---|---|---|---|---|---|---|---|
| | | | | | | | | Nitric Acid | Nitric Acid |
| | | | | | | | | Resistance | Weight Loss |
| Sample | | | | | | | | Parameter | Parameter |
| # | Si | Al | Fe | Ca | Mg | Na | K | (sum of ppm) | (wt. %) |
| CS-1 | 136 | 395 | 28 | 63 | 18 | 560 | 364 | 1564 | 0.49 |
| CS-2 | 251 | 1113 | 45 | 98 | 57 | 665 | 626 | 2855 | 0.68 |
| CS-3 | 359 | 962 | 63 | 158 | 20 | 757 | 844 | 3163 | 0.79 |
| CS-4 | 369 | 303 | 33 | 118 | 11 | 529 | 275 | 1638 | 0.1 |
| CS-5 | 684 | 820 | 73 | 170 | 22 | 935 | 848 | 3552 | 0.3 |
| CS-6 | 1267 | 14790 | 11 | 428 | 18 | 728 | 34 | 17276 | 11.5 |

The finally formed comparative samples CS1, and CS3-CS6 were tested to determine their HCl acid resistance parameters according to the tests described herein. The elemental analysis from the tests of each finally formed comparative sample CS1-CS6 along with the final HCl acid resistance parameter are summarized in Table 11 below.

TABLE 11
HCl Acid Resistance Data for Comparative
Samples CS1, and CS3-CS6

| | Leached Components (ppm) | | | | | | | |
|---|---|---|---|---|---|---|---|---|
| | | | | | | | | HCL Acid |
| | | | | | | | | Resistance |
| | | | | | | | | Parameter |
| Sample | | | | | | | | (sum of |
| # | Si | Al | Fe | Ca | Mg | Na | K | ppm) |
| CS-1 | 571 | 1102 | 185 | 106 | 33 | 1105 | 678 | 3780 |
| CS-3 | 1124 | 2562 | 196 | 233 | 42 | 1156 | 1299 | 6612 |
| CS-4 | 932 | 526 | 63 | 152 | 16 | 850 | 386 | 2925 |
| CS-5 | 1352 | 1388 | 131 | 187 | 30 | 1274 | 1125 | 5487 |
| CS-6 | 1643 | 40380 | 25 | 450 | 20 | 766 | 42 | 43326 |

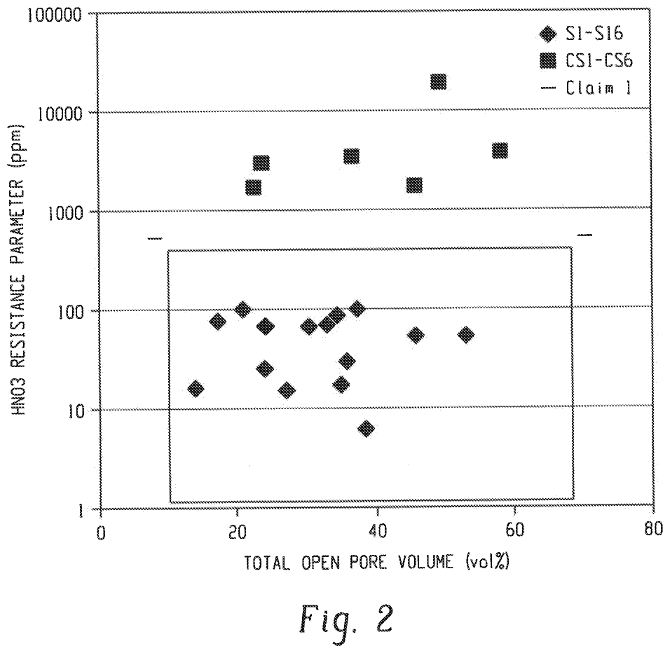

FIG. 2 includes a plot of the “Total Open Porosity” versus the “Nitric Acid Resistance Parameter” measured for the porous ceramic media samples S1-S16 formed according to embodiments described herein and the comparative samples CS1-CS6. As clearly illustrated in the figure, porous ceramic media samples S1-S16 unexpectedly showed lower nitric acid resistance parameters (i.e., better acid resistance properties) while having a relatively high level of total open porosity (i.e., greater than 25 vol. % total open porosity) as compared to the comparative samples.

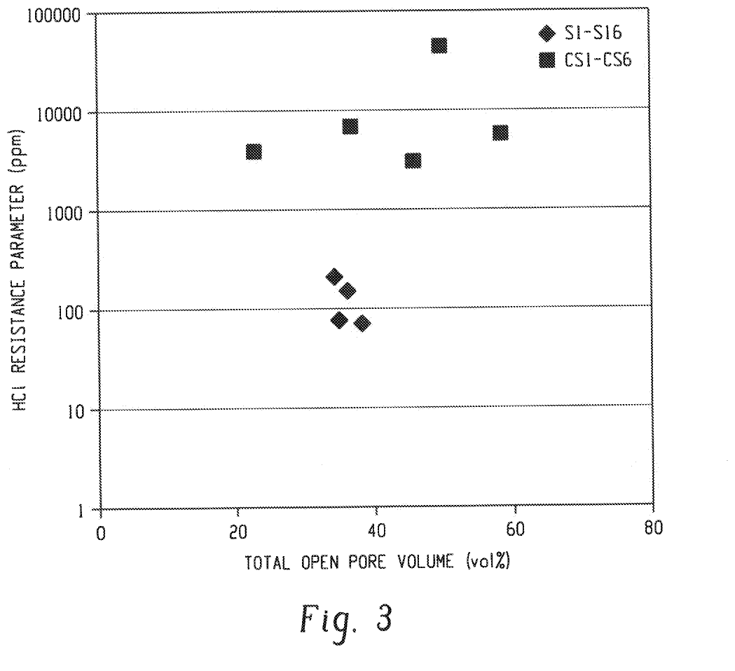

FIG. 3 includes a plot of the “Total Open Porosity” versus the “HCl Acid Resistance Parameter” measured for the porous ceramic media samples S1-S16 formed according to embodiments described herein and the comparative samples CS1-CS6. Again, as clearly illustrated in the figure, porous ceramic media samples S1-S16 unexpectedly showed lower HCl acid resistance parameters (i.e., better acid resistance properties) while having a relatively high level of total open porosity (i.e., greater than 25 vol. % total open porosity) as compared to the comparative samples.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A porous ceramic media comprising:
a chemical composition comprising SiO₂, Al₂O₃, an alkali component and a secondary metal oxide component selected from the group consisting of an Fe oxide, a Ti oxide, a Ca oxide, a Mg oxide and combinations thereof;
a phase composition comprising amorphous silicate, quartz and mullite;
a total open porosity content of at least about 10 vol. % and not greater than about 70 vol. % as a percentage of the total volume of the ceramic media, and
a nitric acid resistance parameter of not greater than about 500 ppm.

2. The porous ceramic media of claim 1, wherein the chemical composition comprises:
a content of SiO₂ of at least about 65.0 wt. % and not greater than about 85.0 wt. % as a percentage of the total weight of the porous ceramic media;
a content of Al₂O₃ of at least about 10 wt. % and not greater than about 30 wt. % as a percentage of the total weight of the porous ceramic media;
a content of the alkali component of at least about 2 wt. % and not greater than about 8 wt. % as a percentage of the total weight of the porous ceramic media; and
a content of the secondary metal oxide component of at least about 1 wt. % and not greater than about 5 wt. % as a percentage of the total weight of the porous ceramic media.

3. The porous ceramic media of any one of claims 1 and 2, wherein the alkali component comprises Na₂O, K₂O, Li₂O or a combination thereof.

4. The porous ceramic media of claim 1, wherein the media comprises at least about 20 vol. % open porosity as a percentage of the total volume of the porous ceramic media.

5. The porous ceramic media of claim 1, wherein the porous ceramic media comprises a nitric acid resistance parameter of not greater than about 150 ppm.

6. The porous ceramic media of claim 1, wherein the porous ceramic media comprises a nitric acid weight loss parameter of not greater than about 0.25 wt. %.

7. The porous ceramic media of claim 1, wherein the porous ceramic media comprises spherical media.

8. The porous ceramic media of claim 7, wherein the spherical media comprises an average diameter of at least about 0.3 mm and not greater than about 50 mm.

9. The porous ceramic media of claim 1, wherein the porous ceramic media comprises non-spherical media.

10. The porous ceramic media of claim 9, wherein the non-spherical media comprises an average diameter of at least about 0.3 mm and not greater than about 50 mm.

11. A method of forming a porous ceramic media, wherein the method comprises:
providing a raw material mixture comprising clay, feldspar, raw perlite, and SiC; and
forming the raw material mixture into a porous ceramic media, wherein the porous ceramic media comprises:
a phase composition comprising amorphous silicate, quartz and mullite;
a total porosity content of at least about 0.10 cc/g and not greater than about 0.6 cc/g, and
a nitric acid resistance parameter of not greater than about 500 ppm.

12. The method of claim 11, wherein the raw material mixture comprises a clay content of at least about 20 wt. % and not greater than about 60 wt. % as a percentage of the total weight of the raw material mixture.

13. The method of claim 11, wherein the raw material mixture comprises a feldspar content of at least about 10 wt. % and not greater than about 30 wt. % as a percentage of the total weight of the raw material mixture.

14. The method of claim 11, wherein the raw material mixture comprises a raw perlite content of at least about 20 wt. % and not greater than about 50 wt. % as a percentage of the total weight of the raw material mixture.

15. The method of claim 11, wherein the raw material mixture comprises SiC content of at least about 0.05 wt. % and not greater than about 0.25 wt. % as a percentage of the total weight of the raw material mixture.
